(19) United States
(12) Patent Application Publication
(10) Pub. No.: US 2020/0354111 A1
(43) Pub. Date: Nov. 12, 2020

(54) RECLOSABLE PACKAGING INCLUDING A RECLOSABLE FILM AND METHOD OF MAKING THE SAME

(71) Applicant: Dow Global Technologies LLC, Midland, MI (US)

(72) Inventors: Vivek Kalihari, Freeport, TX (US); Chuan-Yar Lai, Houston, TX (US); Erica Spiekermann, Freeport, TX (US); Cristina Serrat, Freeport, TX (US); Ronald Wevers, Terneuzen (NL); Marc S. Black, Midland, MI (US); Chad V. Schuette, Midland, MI (US); Piyush Soni, Midland, MI (US); Daniel S. Woodman, Midland, MI (US)

(73) Assignee: Dow Global Technologies LLC, Midland, MI (US)

(21) Appl. No.: 16/640,498

(22) PCT Filed: Sep. 21, 2018
(86) PCT No.: PCT/US2018/052200

§ 371 Date: Feb. 20, 2020

Related U.S. Application Data
(60) Provisional application No. 62/562,057, filed on Sep. 22, 2017.

(51) Int. Cl. B65D 33/20; B65D 75/58; B65D 33/08; B65D 75/00

(52) U.S. Cl. CPC B65D 33/20; B65D 75/5855; B32B 2250/40; B65D 75/008; B32B 2250/03; B65D 33/08

(57) ABSTRACT

A reclosable package (600) includes a container (602) having an elongate closure region (610) proximate to one edge (608) of the container and bounded on both ends by edge seal regions (620). The closure region includes a reclosable film (630) that seals the container proximate to the edge of the container and has an initial opening strength less than a seal strength of the edge seal regions. Application of an opening force to the reclosable film that is greater than the initial opening strength of the reclosable film may be operable to separate the reclosable film and expose a first reclose surface and a second reclose surface. Contact of the first reclose surface with the second reclose surface and application of a pressure to the reclosable film may be operable to re-adhere the first reclose surface and second reclose surface at a reclose strength.

### CROSS REFERENCE TO RELATED APPLICATIONS

This application claims priority to U.S. Provisional Patent Application No. 62/562,057, filed Sep. 22, 2017, the contents of which are hereby incorporated by reference in their entirety.

### TECHNICAL FIELD

Embodiments of the present disclosure generally relate to reclosable packaging, in particular reclosable packaging that includes reclosable films and methods of making the same.

### BACKGROUND

Convenience is a growing trend in the food packaging industry, with consumers looking for packaging that can be easily handled and used. Reclosability in flexible packaging not only offers consumer convenience, but also provides longer shelf life of the packed product without the need to transfer contents into separate reclose packages, such as a zippered plastic bags or rigid containers with lids, for example. Conventional reclose systems are limited in availability and have shortcomings such as additional fabrication steps or poor processability.

For example, some conventional reclosable packaging utilizes a zipper adhered or sealed to the inner surfaces of the packaging. These packages include a zipper crush zone at either end of the zipper. In the zipper crush zone, heat and pressure are applied to the ends of the zipper to melt and crush the zipper flat to seal the ends of the zipper. However, abrupt changes to the geometric profile of the zipper between the opening section of the zipper and the crush zone may cause leaks between the opening zone and crush zone, which prevents sealing of the reclosable package. Additionally, when these zipper packages are made from non-laminated polyethylene films, the heat and pressure needed to crush the ends of the zipper cause processing problems due to the poor thermal resistance of the polyethylene films.

### SUMMARY

Accordingly, ongoing needs exist for reclosable packaging that can be reclosed to provide a sealed package. Further ongoing needs exist for reclosable packaging that can be made without exposing films, such as polyethylene films to excessive heat.

These needs are met by the reclosable packaging disclosed herein, which includes a container having an elongate closure region positioned proximal to at least one edge of the container and bounded on both ends by edge seal regions. The closure region includes a reclosable film that has an initial opening strength less than a seal strength of the edge seal regions. Initial opening of the reclosable film activates the reclose functionality of the reclosable film. Once activated by initial opening, the reclosable film may be reclosed and reopened through a plurality of reclose cycles.

The reclosable packaging disclosed herein does not require the ends of the closure region to be crushed and, therefore, does not exhibit an abrupt change in the geometric profile of the reclosable film at the interface of the edge seal regions and the closure region. Thus, the closure region may prevent leaks and enable reclosing the package to seal the internal volume of the package against intrusion of particulates and liquids. Additionally, eliminating the process of crushing the ends of the zipper may eliminate exposure of the films used to construct the container to the excessive heat and pressure needed to crush a zipper.

According to one or more embodiments, a package may include a container including an elongate closure region proximate to at least one edge of the container and bounded on both ends by edge seal regions. The closure region may include a reclosable film that seals the container proximate to at least one edge of the container and has an initial opening strength less than a seal strength of the edge seal regions. The application of an opening force to the reclosable film that is greater than the initial opening strength of the reclosable film may be operable to separate the reclosable film to expose a first reclose surface and a second reclose surface, and contact of the first reclose surface with the second reclose surface and the application of a pressure to the reclosable film may be operable to re-adhere the first reclose surface to the second reclose surface at a reclose strength.

According to other embodiments, a method of making a reclosable package may include sealing a first flexible wall of a container to a second flexible wall of the container in an elongate closure region at a first temperature and a first pressure. The closure region may be proximate to at least one edge of the container and may be bounded on both ends by edge seal regions. The closure region may include a reclosable film that may seal the container proximate to at least one edge of the container and may provide reclose functionality to the package after initial opening of the package. The method may also include sealing the first flexible wall to the second flexible wall in the edge seal regions at a second temperature and a second pressure. The second temperature may be different than the first temperature, or the second pressure may be different than the first pressure. An initial opening strength of the closure region may be less than an initial opening strength of the edge seal regions.

Additional features and advantages of the described embodiments will be set forth in the detailed description which follows, and in part will be readily apparent to those skilled in the art from that description or recognized by practicing the described embodiments, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a cross-sectional view of a multilayer film that includes 3 layers, in accordance with one or more embodiments of the present disclosure;

FIG. 2 schematically depicts a cross-sectional view of another multilayer film that includes 4 layers, in accordance with one or more embodiments of the present disclosure;

FIG. 3A schematically depicts a cross-sectional view of the multilayer film of FIG. 1 adhered to a substrate, in accordance with one or more embodiments of the present disclosure;

FIG. 3B schematically depicts a cross-sectional view of the multilayer film of FIG. 3A in which the multilayer film has been initially opened to activate the reclose functionality of the multilayer film, in accordance with one or more embodiments of the present disclosure;

FIG. 3C schematically depicts a cross-sectional view of the multilayer film of FIG. 3B in which the multilayer film has been reclosed following initial opening of the multilayer film, in accordance with one or more embodiments of the present disclosure;

FIG. 3D schematically depicts a cross-sectional view of the multilayer film of FIG. 3C in which the multilayer film has been reopened after being reclosed, in accordance with one or more embodiments of the present disclosure;

FIG. 4A schematically depicts a cross-sectional view of the multilayer film of FIG. 3A taken along reference line 4A-4A in FIG. 3A, in accordance with one or more embodiments of the present disclosure;

FIG. 4B schematically depicts a cross-sectional view of the multilayer film of FIG. 4A in which the multilayer film has been initially opened to activate the reclose functionality of the multilayer film, in accordance with one or more embodiments of the present disclosure;

FIG. 5A schematically depicts a front view of a conventional reclosable package that includes a zipper, in accordance with the prior art;

FIG. 5B schematically depicts a front view of the conventional reclosable package of FIG. 5A in which one of the films is peeled back to display features of the zipper, in accordance with the prior art;

FIG. 5C schematically depicts a cross-sectional view of the conventional package of FIG. 5A taken along reference line 5C-5C in FIG. 5A, in accordance with the prior art;

FIG. 6 schematically depicts a front view of a reclosable package, in accordance with one or more embodiments of the present disclosure;

FIG. 7 schematically depicts a cross-section of a portion of a closure region of the reclosable package of FIG. 6 during initial opening of the package, in accordance with one or more embodiments of the present disclosure;

FIG. 8A schematically depicts a cross-section of a closure region of another embodiment of a reclosable package having a strip of a reclosable film disposed between a first flexible wall and a second flexible wall of the reclosable package, in accordance with one or more embodiments of the present disclosure;

FIG. 8B schematically depicts a perspective view of the strip of reclosable film coupled to the first flexible wall of the reclosable package of FIG. 8A, in accordance with one or more embodiments of the present disclosure;

FIG. 9A schematically depicts another embodiment of a reclosable package, in accordance with one or more embodiments of the present disclosure; and

FIG. 9B schematically depicts yet another embodiment of a reclosable package, in accordance with one or more embodiments of the present disclosure.

### DETAILED DESCRIPTION

Embodiments of the present disclosure are directed to reclosable packaging that includes a reclosable film disposed in a closure region of the packaging. Other embodiments of the present disclosure may be directed to methods for making the reclosable packaging disclosed herein. The reclosable film may include a multilayer film that includes a pressure sensitive adhesive disclosed herein.

As used herein, a “seal” refers to a closure of two or more items in contact, direct or indirect, that is tight enough to prevent passage of unwanted materials through the point or surface of contact. A seal may be mechanical or chemical in nature. For example, a mechanical seal might consist of two rigid surfaces that are interlocked in such a fashion as to prevent movement of the surfaces and movement between the surfaces, such as zippers, snap lids, or similar devices. Examples of chemical seals include solders, welds, adhesives, or similar substances that use a temperature, pressure, or a combination thereof to introduce a chemical composition that prevents movement of two or more items. The seal encompasses the items in contact, the surface or point of contact, and any other materials that might be at the surface or point of contact. The tightness of a seal may vary; hermetic seals, particle-tight seals, dust-tight seals, water-tight seals, liquid-tight seals, air-tight seals, wet gas-tight seals, or dry gas-tight seals are contemplated.

As used herein, melt index (I₂) is a measure of the melt flow rate of a polymer and is generally measured using ASTM D1238 at a temperature of 190° C. and 2.16 kg of load.

As used herein, the Molecular Weight Distribution (MWD) of a polymer is defined as the quotient Mw/Mn, where Mw is a weight average molecular weight of the polymer and Mn is a number average molecular weight of the polymer.

The term “polymer” refers to a polymeric compound prepared by polymerizing monomers, whether of the same or a different type. The generic term polymer thus embraces the term “homopolymer” usually employed to refer to polymers prepared from only one type of monomer as well as “copolymer” which refers to polymers prepared from two or more different monomers. The term “block copolymer” refers to a polymer comprising two or more chemically distinct regions or segments (referred to as “blocks”). In some embodiments, these blocks may be joined in a linear manner, that is, a polymer comprising chemically differentiated units which are joined end-to-end. A “random copolymer” as used herein comprises two or more polymers where each polymer may comprise a single unit or a plurality of successive repeat units along the copolymer chain back bone. Even though some of the units along the copolymer chain backbone exist as single units, these are referred to as polymers herein.

“Polyethylene” or “ethylene-based polymer” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). As used herein, “ethylene/α-olefin random copolymer” is a random copolymer comprising greater than 50% by weight of units derived from ethylene monomer

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm.

The term “LLDPE”, includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.935 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.935 g/cc, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cc, which are generally prepared with Ziegler-Natta catalysts, single-site catalysts including, but not limited to, bis-metallocene catalysts and constrained geometry catalysts, and post-metallocene, molecular catalysts. The term “propylene-based polymer,” as used herein, refers to a polymer that comprises, in polymerized form, refers to polymers comprising greater than 50% by weight of units which have been derived from propylene monomer. This includes propylene homopolymer, random copolymer polypropylene, impact copolymer polypropylene, propylene/a-olefin interpolymer, and propylene/a-olefin copolymer. These polypropylene materials are generally known in the art.

As used herein, the term “styrenic block copolymer” refers to a block copolymer that is produced from the polymerization of styrene monomer and at least one other comonomer.

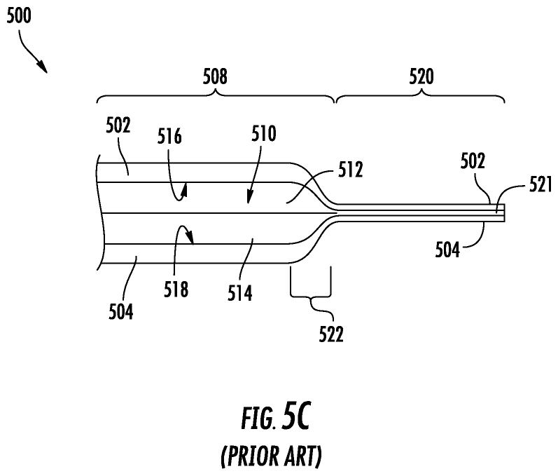

Referring to FIGS. 5A-5C, a conventional reclosable package is illustrated and designated generally by reference number 500. The conventional reclosable package 500 includes a first side 502 and a second side 504 that are sealed together along each longitudinal edge by a longitudinal seal 506. The first side 502 and second side 504 are sealed along one transverse edge by an end seal 507. The conventional reclosable package 500 includes a reclose end 508 opposite the end seal 507 and extending between the two longitudinal seals 506. The reclose end 508 generally includes a zipper 510 or other mechanical reclose feature to provide reclosability to the conventional reclosable package 500.

As shown in FIG. 5B, the zipper 510 may include at least one rib 512 and at least one channel 514. Other mechanical reclose features are also used. The zipper 510 or other mechanical reclose feature is typically made from a polymer such as polyethylene, or polyamide (e.g., nylon). The tab 512 may be adhered or otherwise coupled to the inner surface 516 of the first side 502, and the channel 514 may be adhered or otherwise coupled to the inner surface 518 of the second side 504. To open and close the conventional zippered package 500, the zipper 510 is opened and closed by disengaging and engaging the rib 512 from the channel 514.

The ends of the zipper 510 or other mechanical reclose feature are secured by crushing the ends of the zipper 510 between the first side 502 and the second side 504 in zipper crush zones 520 of the longitudinal seals 506 positioned proximal to the ends of the zipper 510. To crush the ends of the zipper 510 in the zipper crush zones 520, heat and pressure are applied to the first side 502 and the second side 504 of the conventional zippered package 500 in the zipper crush zones 520 to soften or melt the ends of the zipper 510 and deform the ends of the zipper 510 into a thin film 521 disposed between the first side 502 and the second side 504. In many cases, the first side 502 and the second side 504 are made from single polyethylene films or other polymer films having poor thermal resistance. Exposing the first side 502 and second side 504 in the zipper crush zones 520 to the heat and pressure required to crush the ends of the zipper 510 may cause damage to the first side 502 or the second side 504, which may jeopardize the integrity of the first side 502 or the second side 504 of the conventional zipper package 500. The process of making the conventional zipper package 500, also requires the additional steps of adhering the parts of the zipper 510 (e.g., the tab 512 and the 514) to the internal surface 516 of the first side 502 and the inner surface 518 of the second side 518, and then crushing the ends of the zipper 510 in the zipper crush zone 520. Thus, multiple additional manufacturing steps are needed to make the conventional zippered packages of FIGS. 5A-5C.

Referring to FIG. 5C, the zipper 510 undergoes an abrupt change in geometric profile at the interface 522 between the reclose end 508 and the zipper crush zone 520. This abrupt change in geometric profile of the zipper 510 adversely impacts the ability to seat the tab 512 of the zipper 510 in the channel 514 of the zipper 510. In other words, deformation of the zipper 510 at the interface 522 of the reclose end 508 and the zipper crush zone 520 prevents the zipper 510 from properly closing and sealing at the interface 522. Therefore, the abrupt change in geometric profile of the zipper 510 at the interface 522 results in leaks of gases or liquids between the tab 512 and the channel 514 of the zipper 510 at the interface 522.

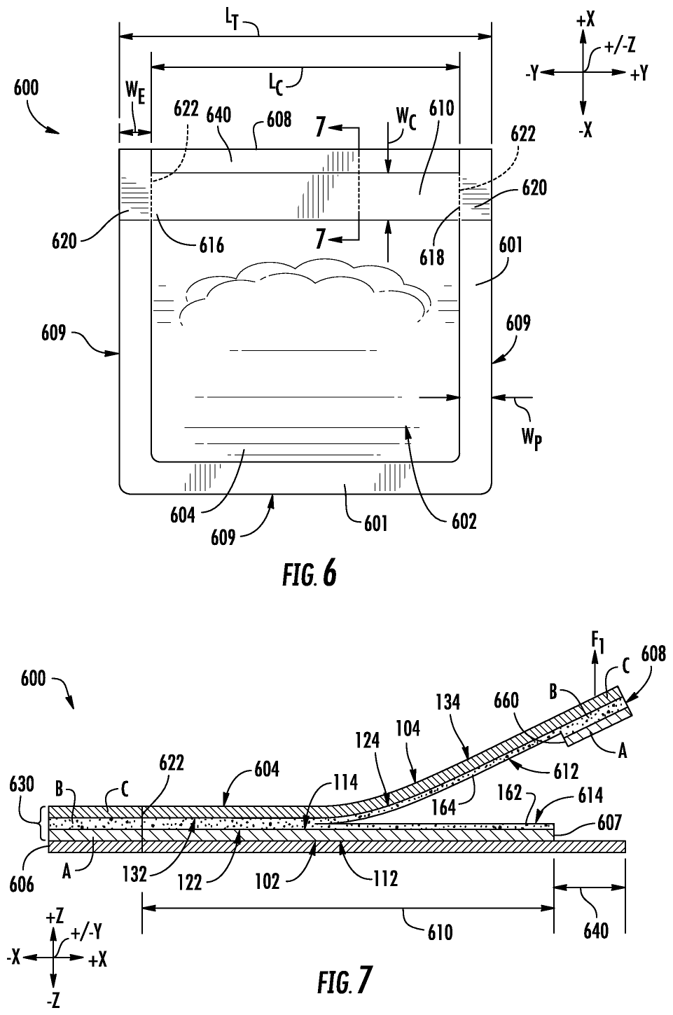

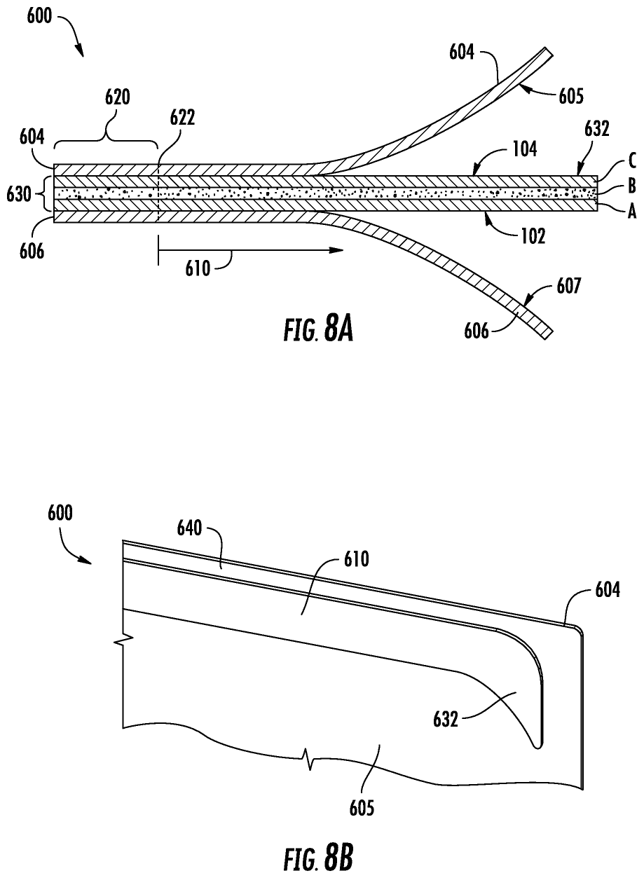

Referring to FIGS. 6 and 7, an embodiment of the reclosable package of the present disclosure is illustrated and generally identified herein by reference number 600. The reclosable package 600 may include a container 602 that includes an elongate closure region 610 proximal to at least one edge 608 of the container 602 and bounded at both ends by edge seal regions 620. The closure region 610 may include a reclosable film 630 (FIG. 7) that seals the container 602 proximal to at least one edge 608 of the container 602. The reclosable film 630 in the closure region 610 may have an initial opening strength less than a seal strength of the edge seal regions 620. Once initially opened, the reclosable film 630 may be reclosed to seal an internal volume of the container 602.

The reclosable package 600 disclosed herein may provide an improved initial seal integrity compared to conventional packaging that include zippers 510 (FIG. 5A) or other mechanical closure features. Additionally, the reclosable package 600 may be produced at lower temperatures and pressures compared to conventional packages that include zippers 510 or other mechanical closure features by eliminating the need to crush the ends of the zipper 510 in the zipper crush zones 520 (FIG. 5A). This may enable the reclosable package 600 to be made from polymer films having lower thermal resistance, such as polyethylene films. Methods of producing the reclosable package 600 may include fewer steps and may be more efficient compared to methods of making the conventional packages that have zippers or other mechanical closures, because the reclosable package 600 does not require mechanical features to be adhered to the inner surfaces of the packaging and then rushed in the zipper crush zones.

Referring to FIGS. 6 and 7, the container 602 may include at least two side walls, such as first side wall 604 and second side wall 606. The first side wall 604 and the second side wall 606 may be sealed together around a peripheral region 601 proximal to the outer edges 608, 609 of the container 602. An inner surface 605 of the first side wall 604 and the inner surface 607 of the second side wall 606 may define the internal volume of the container 602. The internal volume of the container 602 may additionally be bound and defined by the closure region 610 and the edge seal regions 620 along the peripheral region 601 of the container 602.

In some embodiments, the container 602 may be a rigid or partially rigid container in which the first side wall 604, the second side wall 606, or both may include a rigid material. Alternatively, in other embodiments, the container 602 may be a flexible container, having at least a portion of the container 602 that includes a flexible side wall. For example, the first side wall 604 may include a first flexible wall, the second side wall 606 may include a second flexible wall, or the first side wall 604 may include the first flexible wall and the second side wall 606 may include the second flexible wall. The first flexible wall, the second flexible wall, or both may include a flexible film.

Referring to FIG. 6, the peripheral region 601 of the container 602 may include a region of the container 602 proximal to the outer edges 608, 609 of the container 602. The peripheral region 601 may have a width W_{P} measured inward from the outer edge 608, 609 of the container 602. The peripheral region 601 of the container 602 may include the closure region 610 proximal to one outer edge 608 of the container 602 and edge seal regions 620 proximal to the other outer edges 609 of the container 602.

The closure region 610 may initially seal the first side wall 604 to the second side wall 606. Initial opening of the closure region 610 may provide access to the contents of the reclosable package 600. As previously described, the closure region 610 may include an elongate region proximate to and parallel to the outer edge 608 of the container 602. The closure region 610 may be bounded at a first end 616 and a second end 618 by the edge seal regions 620. The closure region 610 may have a length L_{C} measured as the distance between the first end 616 and the second end 618 of the closure region. The length L_{C} of the closure region 610 may be less than the total length L_{T} of the outer edge 608, including the closure region 610 and the end seal regions 620. The closure region 610 may have a width W_{C} that is different and a width W_{E} of the edge seal regions 620 or the width W_{P} of the peripheral region 601 of the container 602. In some embodiments, the width W_{C} of the closure region 610 may be greater than the width W_{E} of the edge seal regions 620. Alternatively, in some embodiments, the width W_{C} of the closure region 610 may be less than or equal to the width W_{E} of the edge seal regions 620.

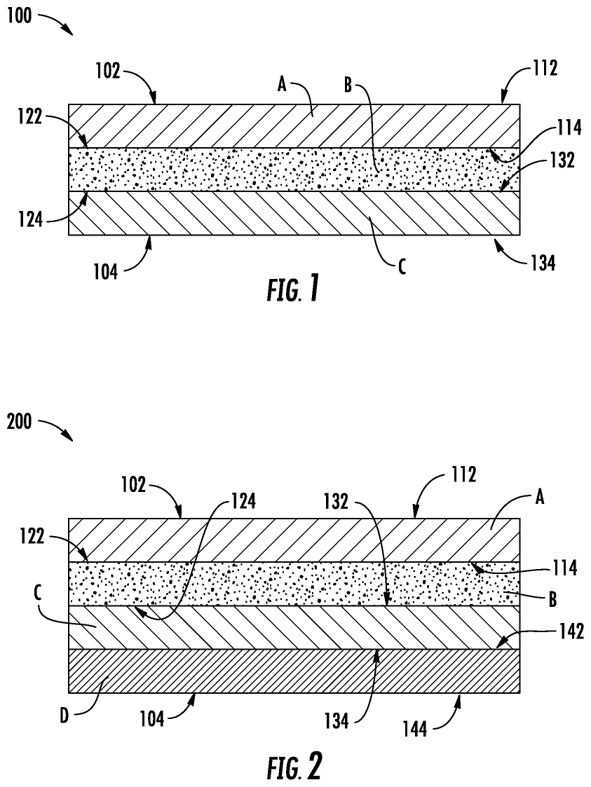

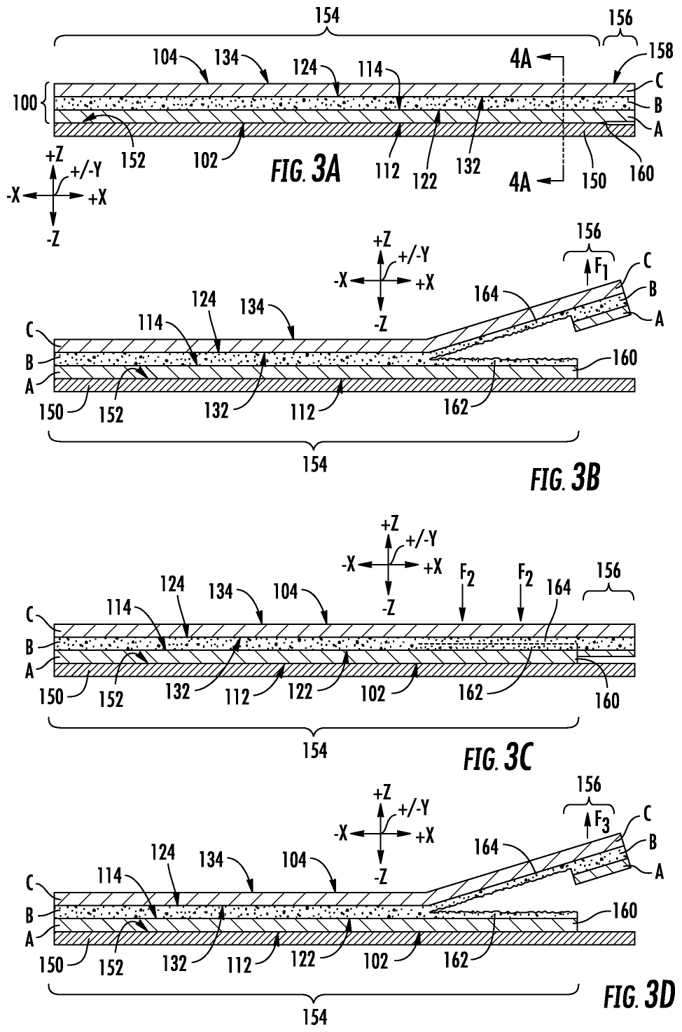

Referring to FIG. 7, the closure region 610 may include the reclosable film 630. Once initially opened, the reclosable film 630 may be activated and may provide reclose/reopen functionality to the closure region 610. The reclosable film 630 may include a multilayer film, such as the multilayer films 100, 200 (FIGS. 1 and 2) subsequently described in this disclosure. In some embodiments, the reclosable package 600 does not include a zipper or other mechanical closure device.

The reclosable film 630, as well as the other multilayer films comprising the combinations of layers disclosed herein, can advantageously be prepared in a single coextrusion step. For example, multilayer films of the present invention can be blown films or cast films. The ability to prepare the reclosable films 630 in a single coextrusion step is particularly advantageous where such films are to be used in aseptic packaging applications as such multilayer films traditionally require multiple processing steps (e.g., extrusion of multiple films followed by a lamination step and curing). Thus, reclosable film 630 of the present invention can advantageously be prepared in a single coextrusion step while also providing one or more properties desirable for aseptic packaging applications.

The reclosable film 630, as well as the other multilayer films comprising the combinations of layers disclosed herein, can be coextruded as blown films or cast films using techniques known to those of skill in the art based on the teachings herein. In particular, based on the compositions of the different film layers disclosed herein, blown film manufacturing lines and cast film manufacturing lines can be configured to coextrude the reclosable films 630 and multilayer films of the present disclosure in a single extrusion step using techniques known to those of skill in the art based on the teachings herein. In one or more embodiments, after the reclosable film 630 is formed, but before it is incorporated into the reclosable package 600, the reclosable film 630 may be laminated to one or more other films.

Referring to FIG. 7, the reclosable film 630 is illustrated that includes at least three layers: Layer A, Layer B, and Layer C. The reclosable film 630 will be described relative to an embodiment having three layers; however, the reclosable film 630 may have more than three layers, such as 4, 5, 6, 7, 8, or more than 8 layers. The reclosable film 630 may have a film top facial surface 102 and a film bottom facial surface 104. Similarly, each of the layers A, B, and C may have opposing facial surfaces, such as a top facial surface and a bottom facial surface. As used in this disclosure, the term “top” refers to the facial surface of the multilayer oriented toward the Layer A side of the reclosable film 630, and the term “bottom” refers to the opposite side of the reclosable film 630 oriented away from the Layer A side of the reclosable film 630.

Layer A may have a top facial surface 112 and a bottom facial surface 114. The top facial surface 112 of Layer A may be the film top facial surface 102 of the reclosable film 630. The bottom facial surface 114 of Layer A may be in adhering contact with the top facial surface 122 of Layer B. Layer A is a sealing layer that includes a sealing composition capable of sealing the film top facial surface 102 of the reclosable film 630 to the first side wall 604 or the second side wall 606. For example, in some embodiments, the sealing composition may be a heat sealing composition. In some embodiments, the sealing composition may include a polyolefin. For example, in some embodiments, the sealing composition of Layer A may include at least one of low density polyethylene (LDPE), linear low density polyethylene (LLDPE), ultra-low density polyethylene (ULDPE), other sealing composition known to those of skill in the art, or combinations of these. The sealing composition of Layer A may have an internal cohesion strength that is greater than the internal cohesion strength of a composition of Layer B. However, the internal cohesion strength of Layer A may be low enough so that the magnitude of the initial opening force needed to initially open the reclosable film 630 and activate the reclose/reopen functionality is not substantially greater than 40 Newtons per inch (N/in).

Referring to FIG. 7, Layer B includes the top facial surface 122 and a bottom facial surface 124. The top facial surface 122 of Layer B may be in adhering contact with the bottom facial surface 114 of Layer A. Additionally, the bottom facial surface 124 of Layer B may be in adhering contact with a top facial surface 132 of Layer C. Thus, Layer B is positioned adjacent to Layer A and in adhering contact with Layer B, and Layer B is disposed between Layer A and Layer C. Layer B may include a composition, such as any of the compositions subsequently described in this disclosure. In some embodiments, the composition of Layer B may be an adhesive composition, such as a pressure sensitive adhesive composition, for example.

Layer C includes the top facial surface 132 and a bottom facial surface 134. As previously discussed, the top facial surface 132 of Layer C may be in adhering contact with the bottom facial surface 124 of Layer B. In some embodiments, the bottom facial surface 134 of Layer C may comprise the film bottom facial surface 104 of the reclosable film 630, such as when the reclosable film 630 includes three layers. In some embodiments, Layer C may be a structural layer that may provide strength and stiffness to the multilayer film 100. In some embodiments, Layer C may include a polymer or copolymer comprising at least an ethylene monomer, such as, but not limited to high density polyethylene (HDPE), medium density polyethylene (MDPE), low density polyethylene (LDPE), linear low density polyethylene (LLDPE), very low density polyethylene (VLDPE), or combinations of these. In other embodiments, Layer C may include other polymer film materials, such as polyamides (e.g., nylon), polypropylene, polyesters such as polyethylene terephthalate (PET) for example, polyvinyl chloride, other thermoplastic polymers, or combinations of these. In other embodiments, Layer C may be a sealant layer that includes any of the sealant compositions previously discussed in relation to Layer A. Although described relative to a three layer film, the reclosable film 630 may also include one or more than one subsequent layers to provide additional properties to the reclosable film 630, as described subsequently in relation to multilayer film 100.

In some embodiments, Layer A, which includes the sealing composition, may be sealed to the first side wall 604 (e.g., first flexible film) or the second side wall 606 (e.g., second flexible film) in the closure region 610, Layer B may include the composition having an internal cohesion strength less than the seal strength of Layer A, and Layer C may include a structural material or a sealant. Layer B may include a top facial surface 122 in adhering contact with a bottom facial surface 114 of Layer A and a bottom facial surface 124 in adhering contact with a top facial surface 132 of Layer C.

In some embodiments, the first side wall 604, the second side wall 606, or both may include the reclosable film 630. For example, in some embodiments, the first side wall 604 may include the reclosable film 630. As illustrated in FIG. 7, the reclosable film 630 may be oriented so that a top facial surface 102 of the reclosable film 630 faces towards the inner surface 607 of the second side wall 606. In the closure region 610, the top facial surface 102 of the reclosable film 630 of the first side wall 604 may be in adhering contact with and sealed to the inner surface 607 of the second side wall 606. The top facial surface 102 of the reclosable film 630 of the first side wall 604 may also be in adhering contact with and sealed to the inner surface 607 of the second side wall 606 in the end seal regions 620. Layer C of the reclosable film 630 may be the outer surface of the first side wall 604.

Alternatively, in some embodiments, the first side wall 604 and the second side wall 606 may both include the reclosable film 630. In these embodiments, the reclosable films 630 of the first side wall 604 and the second side wall 606 may be oriented so that Layer A of each reclosable film 630 is positioned inward facing the internal volume of the container 602. Layer C may face generally outward away from the internal volume of the container 602. In some embodiments, Layer C of the reclosable films 630 may be the outer surfaces of the first side wall 604 and the second side wall 606. In the closure region 610, the top facial surface 102 of the reclosable film 630 of the first side wall 604 may be in adhering contact with the top facial surface 102 of the reclosable film 630 of the second side wall 604. The top facial surfaces 102 of the reclosable films 630 of the first side wall 604 and the second side wall 606 may also be in adhering contact in the edge seal regions 620.

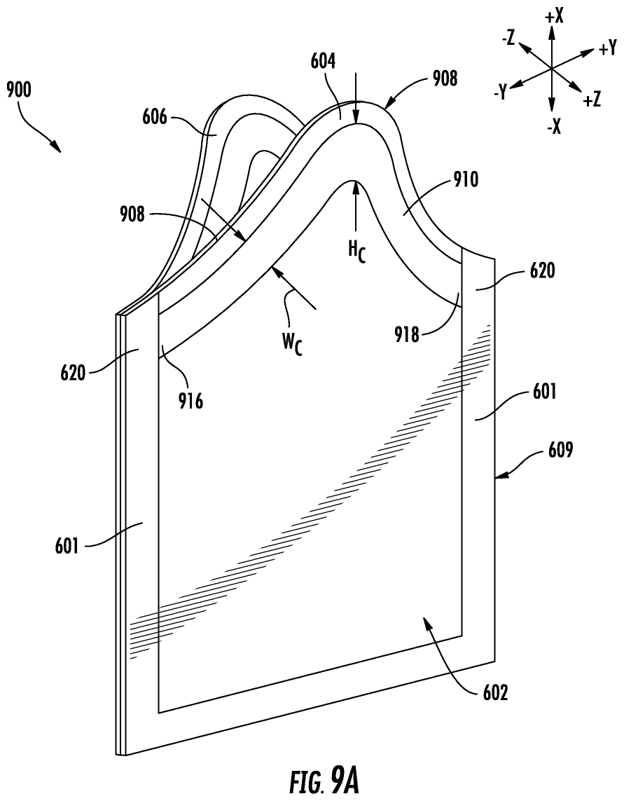

Referring to FIGS. 8A and 8B, in still other embodiments, the reclosable film 630 may be disposed between a first side wall 604 and a second side wall 606 of the container 602 in the closure region 610. In these embodiments, the film top facial surface 102 of the reclosable film 630 may be in adhering contact with the inner surface 607 of the second side wall 606 in the closure region 610. The film bottom facial surface 104 of the reclosable film 630 may be in adhering contact with the inner surface 605 of the first side wall 604. Referring to FIG. 8B, in some embodiments, the reclosable film 630 may comprise a strip 632 of the reclosable film 632 disposed in the closure region 610 between the first side wall 604 and the second side wall 606. In some embodiments, the strip 632 of the reclosable film 630 may extend at least the entire length L_{C} (FIG. 6) of the closure region 610 from the first end 616 to the second end 618. In other embodiments, the strip 632 of the reclosable film 630 may extend past the first end 616 and/or the second end 618 of the closure region 610 and through at least a portion of the edge seal regions 620 bounding the closure region 610. In other words, the width of the strip 632 of the reclosable film 630 may have a length greater than the length L_{C} of the closure region 610.

Referring again to FIG. 8A, the reclosable film 630 of the strip 632 may be a multilayer film, such as any of the multilayer films 100, 200 described subsequently in this disclosure. For example, in some embodiments, the reclosable film 630 of the strip may be a multilayer film having three layers. In some embodiments, Layer A of the multilayer film may include a sealant and, Layer B may include the composition having an internal cohesion strength less than the seal strength of Layer A, and Layer C may include a sealant. Layer B includes a top facial surface 122 in adhering contact with a bottom facial surface 114 of Layer A and a bottom facial surface 124 in adhering contact with a top facial surface 132 of Layer C. In some embodiments, Layer C may include the same sealant as Layer A. In other embodiments, the sealant of Layer C may be different than the sealant of Layer A. Layer C may be in adhering contact with the inner surface 605 of the first side wall 604 in the closure region 610. Layer C may also be in adhering contact with the inner surface 605 of the first side wall 604 in the edge seal regions 620. Likewise, Layer A may be in adhering contact with the inner surface 607 of the second side wall 606 in the closure region 610 and the edge seal regions 620. Although described herein in the context of a three layer film, the reclosable film 630 may include more than three layers as subsequently described in relation to multilayer films 100, 200 (FIGS. 1 and 1).

Referring again to FIG. 6, the edge seal regions 620 may be disposed at the first end 616 and the second end 618 of the closure region 610. In some embodiments, the reclosable film 630 of the closure region 610 may extend into the edge seal regions 620, for example when either the first side wall 604 or the second side wall 606 comprises the reclosable film 630 or when the strip 632 of the reclosable film 630 extends into the edge seal regions 620. The edge real regions 620 may be disposed in at least a portion of the peripheral region 601. In some embodiments, the edge seal region 620 may extend through the peripheral region 601 from the first end 616 of the closure region 610 to the second end 618 of the closure region 610.

The closure region 610 and the edge seal regions 620 may cooperate to initially seal the outer edge 608 of the package 600, prior to initially opening the package. In some embodiments, the closure region 610 and the edge seal regions 620 may cooperate to form a liquid tight seal along the outer edge 608 of the package 600 sufficient to prevent liquids from penetrating through the closure regions 610 and edge seal regions 620 to the internal volume of the container 602. In other embodiments, the closure region 610 and the edge seal regions 620 may cooperate to form a moisture tight seal along the outer edge 608 of the package 600 sufficient to prevent liquid water or water vapor from penetrating through the closure regions 610 and edge seal regions 620 to the internal volume of the container 602. In still other embodiments, the closure region 610 and the edge seal regions 620 may cooperate to form an air tight seal along the outer edge 608 of the package 600 sufficient to prevent air from penetrating through the closure regions 610 and edge seal regions 620 to the internal volume of the container 602.

In some embodiments, the seal formed by cooperation of the closure region 610 and the edge seal regions 620 may exhibit a seal integrity sufficient to prevent intrusion of particulates into the internal volume of the container 602. In other embodiments, the seal integrity of the seal formed by cooperation of the closure region 610 and the edge seal regions 620 may be sufficient to prevent intrusion of liquids into the internal volume of the container 602. In other embodiments, the seal integrity of the seal formed by cooperation of the closure region 610 and the edge seal regions 620 may be sufficient to prevent intrusion of moisture into the internal volume of the container 602. In still other embodiments, the seal integrity of the seal formed by cooperation of the closure region 610 and the edge seal regions 620 may be sufficient to prevent intrusion of air into the internal volume of the container 602.

The edge seal regions 620 may have an initial seal strength that is greater than the initial seal strength of the closure region 610. An initial opening force to open the closure region 610 may, therefore, be greater than the initial seal strength of the closure region 610 but less than the initial seal strength of the edge seal regions 620. Thus, when the reclosable package 600 is initially opened, the closure region 610 of the reclosable package 600 may be opened from the first end 616 to the second end 618, and the edge seal regions 620 may remain sealed when exposed to the initial opening force.

The closure region 610 and the edge seal regions 620 may be initially sealed by applying heat and pressure to the closure region 610 and the edge seal regions 620 to seal the first side wall 604 to the second side wall 606. The initial seal strengths of the end seal regions 620 and the closure region 610 may be influenced by the temperature and pressure used to initially seal the reclosable package 600. For example, in some embodiments, the edge seal regions 620 may be sealed under conditions of temperature and/or pressure that are different than the conditions of temperature and/or temperature under which the closure region 610 is sealed. The different sealing conditions for sealing the edge seal regions 620 compared to the temperature and pressure conditions for sealing the closure region 610 may result in the initial seal strength of the edge seal regions 620 greater than the initial seal strength of the closure region 610. For example, in some embodiments, the edge seal regions 620 may be initially sealed at a first temperature, and the closure region 610 may be initially sealed at a second temperature less than the first temperature, which may result in edge seal regions 620 having an initial seal strength greater than the initial seal strength of the closure region 610. In other embodiments, the edge seal regions 620 may be initially sealed at a first pressure, and the closure region 610 may be initially sealed at a second pressure less than the first temperature, which may result in edge seal regions 620 having an initial seal strength greater than the initial seal strength of the closure region 610.

The initial seal strengths of the closure region 610 and the end seal regions 620 may also be influenced by seal width (e.g., the width W_{C} of the closure region 610 or width W_{E} of the edge seal regions 620) or by the compositions of the films or film layers of the first side wall 604, second side wall 606, and/or strip 632 of reclosable film 630. For example, in some embodiments, the width W_{C} of the closure region 610 may be different than the width W_{E} of the edge seal regions 620, which may result in initial seal strength of the closure region 610 being different than the initial seal strength of the edge seal regions 620.

Referring to FIG. 6, the reclosable package 600 may further include an unsealed region 640 disposed between the closure region 610 and the at least one edge 608 of the container 602. The unsealed region 640 may provide purchase for applying an initial opening force to the closure region 610. For example, the unsealed region 640 may comprise a tab that may be used to pull the first side wall 604 away from the second side wall 606 in the closure region 610. In some embodiments, the unsealed region 640 may be elongate and parallel to the closure region 610. In some embodiments, the unsealed region 640 may extend an entire length L_{C} of the closure region 610.

Referring to FIG. 7, the reclosable package 600 may be initially opened at the closure region 610 to activate the reclose/reopen functionality of the reclosable film 630 in the closure region 610. The reclose/reopen functionality of the reclosable film 630 is not activated until the reclosable package 600 is initially opened. During initial opening of the reclosable package 600, an initial opening force F1 may be applied to the reclosable film 630 at the outer edge 608 in a direction needed to pull the first side wall 604 away from the second side wall 606 in the closure region 610. For example, the first side wall 604 may be grasped in one hand, the second side wall 606 may be grasped in the other hand, and the first side wall 604 and the second side wall 606 may be pulled away from each other at the closure region 610.

Referring to FIG. 7, as will be described in more detail in this disclosure, upon applying the initial opening force F1 to the first side wall 604 and the second side wall 606 in the closure region 610, Layer A of the reclosable film 630 may fail in a direction generally perpendicular to the film top facial surface 102 of the reclosable film 630 (i.e., in the +/−Z direction of the coordinate axis in FIG. 7) an the interface 660, which is at a transition between the unsealed region 640 and the closure region 610. Layer B may then cohesively fail in a direction generally parallel to the film top facial surface 102 of the reclosable film (i.e., in the +/−X direction of the coordinate axis in FIG. 7). Cohesive failure of Layer B of the reclosable film 630 may result in a first portion 162 of the composition of Layer B coupled to the bottom facial surface 114 of Layer A and the second portion 164 of the composition of Layer B coupled to the top facial surface 132 of Layer C. Thus, the application of the initial opening force F1 to the reclosable film 630 that is greater than the initial opening strength of the reclosable film 630 may be operable to separate the reclosable film 630 to expose a first reclose surface 612 and a second reclose surface 614.

At the other side of the closure region 610, continued application of the opening force F1 may cause Layer A to fail again in a direction generally perpendicular to the film top facial surface 102 of the reclosable film 630 (i.e., in the +/−Z direction of the coordinate axis in FIG. 7) at a transition between the closure region 610 and the internal volume unsealed portions of the first side wall 604 and second side wall 606 defining the internal volume of the container 602, thereby fully opening the reclosable package 600. Initial opening of the reclosable film 630 may provide an indication to a consumer or other user that the reclosable package 600 has been previously opened. For example, failure of Layer A at interface 660 and cohesive failure of Layer B in the closure region 610 to separate Layer B into the first portion 162 and second portion 164 of the composition of Layer B may provide physical indicators that the reclosable film has been initially opened.

The reclosable package 600 may be reclosed by returning the first portion 162 of the composition of Layer B into contact with the second portion 164 of the composition of Layer B in the closure region 610. A reclose pressure may be applied to the reclosable film 630 in the closure region 610 to adhere the first portion 162 and the second portion 164 of the composition of Layer B together to reclose and reseal the closure region 610 of the reclosable package 600. Thus, contacting of the first reclose surface 612 with the second reclose surface 614 of the reclosable film 630 and the application of a reclose pressure to the reclosable film 630 may be operable to re-adhere the first reclose surface 612 to the second reclose surface 614 at a reclose strength.

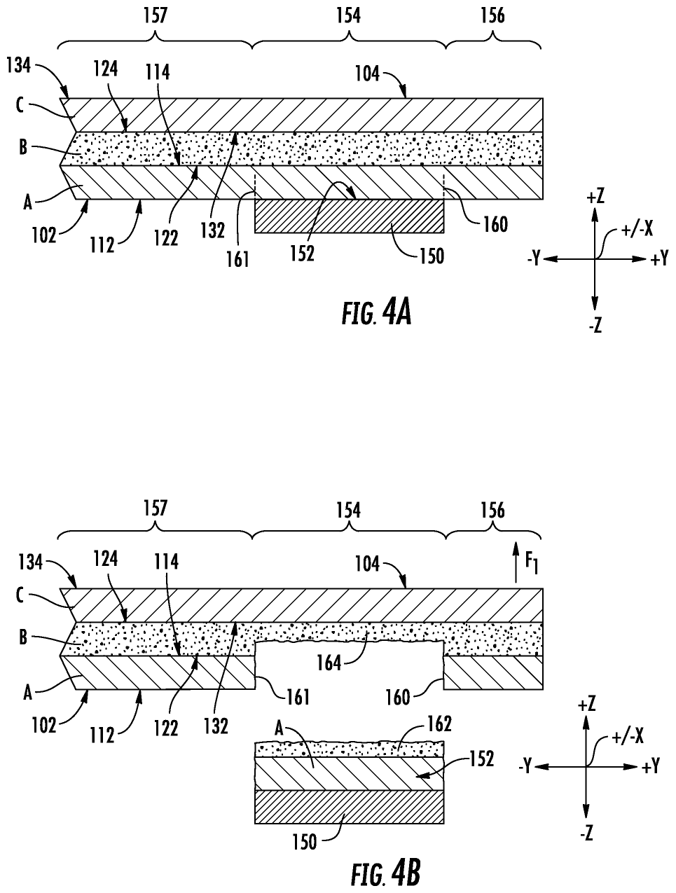

The reclosable package 600 may be reopened by again applying a reopening force to pull the reclosable film 630 apart again in the closure region 610. The reopening force may be greater than the reclose strength of the adhesive bond between the first reclose surface 612 and the second reclose surface 614. Reopening and reclosing the reclosable film 630 is further described herein in relation to FIGS. 3A-3D illustrating initially opening, reclosing, and reopening of the multilayer film 100. The reclosable package 600 may be reclosed and reopened through a plurality of reclose/reopen cycles.

The method of making the reclosable package 600 may also include sealing the first side wall 604 (e.g., first flexible wall) of the container 602 to the second side wall 606 (e.g., second flexible wall) of the container 602 in the elongate closure region 610 at a first temperature and a first pressure. The closure region 610 may be proximate to the at least one edge 608 of the container 602 and is bounded on both ends (i.e., first end 616 and second end 618) by the edge seal regions 620. The closure region 610 may include the reclosable film 630 that may seal the container 602 proximate to the at least one edge 608 of the container 602 and may provide reclose functionality to the reclosable package 600 after initial opening of the reclosable package 600. The method of making the reclosable package 600 may also include sealing the first side wall 604 to the second side wall 606 in the edge seal regions 620 at a second temperature and a second pressure.

The second temperature may be different than the first temperature or the second pressure may be different than the first pressure. For example, in some embodiments, the second temperature may be greater than the first temperature. In some embodiments, the first temperature may be from 100° C. to 180° C., such as 100° C. to 160° C., from 100° C. to 150° C., from 120° C. to 180° C., from 120° C. to 160° C., from 120° C. to 150° C., from 130° C. to 180° C., from 130° C. to 160° C., or from 130° C. to 150° C. Additionally, in some embodiments, the second pressure may be greater than the first pressure. The sealing may include heat sealing and may be performed with commercially available heat sealing machines or equipment. The difference in sealing conditions between the closure region 610 and the edge seal regions 620 may result in different seal strengths for the closure region 610 and the edge seal regions 620. In some embodiments, the initial opening strength of the closure region 610 may be less than an initial opening strength of the edge seal regions 620.

In some embodiments, the method of making the reclosable package 600 may include providing a first flexible film for the first side wall 604 and providing a second flexible film for the second side wall 606. The first flexible film, the second flexible film or both may include the reclosable film 630. In other embodiments, the method may include positioning a strip 632 of reclosable film 630 between the first side wall 604 and the second side wall 606 in the closure region 610. In some embodiments, the strip 632 of reclosable film 630 may be positioned between the first side wall 604 and the second side wall 606 before sealing the closure region 610.

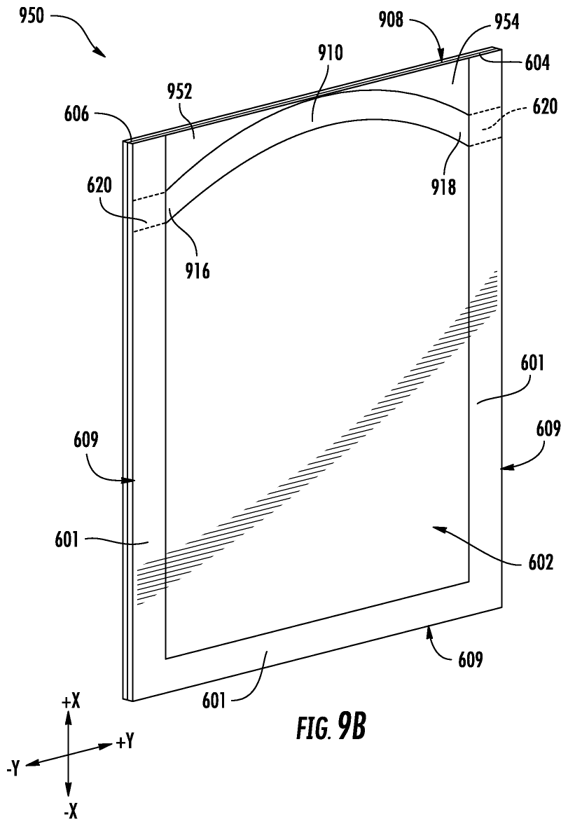

Referring to FIG. 9A, another embodiment of the reclosable package 900 may include a closure region 910 that is non-linear, such that the closure region 910 does not proceed in a straight line from a first end 916 of the closure region 910 to a second end 918 of the closure region 908. The incorporation of the reclosable film 630 into the reclosable package 900 may enable the closure region 910 to have a non-linear shape, such as a curved shape, stepped shape, triangular shape, or other non-linear shape. In contrast, conventional reclosable packages, such as conventional reclose package 500 shown in FIG. 5A, that include zippers or other mechanical closure devices are generally limited to linear closure regions due to the limitations of the closure devices.

Referring to FIG. 9A, in some embodiments, the outer edge 908 may be non-linear and may have a non-linear contour, and the closure region 910 may conform to the non-linear contour of the outer edge 908. The closure region 910 may have height H_{C} measured in a direction parallel to the +/−X axis of FIG. 9A. In some embodiments, the height H_{C} of the closure region 910 may be constant from the first end 916 to the second end 918 of the closure region 910. Alternatively, in other embodiments, the height H_{C} of the closure region 910 may vary from the first end 916 to the second end 918 of the closure region 910. The closure region 910 may have a width W_{C} measured in a direction normal to the outer boundary of the closure region 910. In some embodiments, the width W_{C} of the closure region 910 may be constant from the first end 916 to the second end 918 of the closure region 910. Alternatively, in other embodiments, the width W_{C} of the closure region 910 may vary from the first end 916 to the second end 918 of the closure region 910.

As previously described, incorporating the reclosable film 630 into the closure region 910 may enable the closure region 910 of the reclosable package 900 to be formed into different shapes. These different shapes of the closure region 910 may enable the reclosable package 900 to be made with different exterior shapes, which may make the reclosable package 900 more attractive to consumers. Additionally, incorporating a non-linear closure region 910 may enable the initial opening force needed to open the reclosable package 900 to be reduced by reducing the linear distance over which the initial opening force is distributed during initial opening compared to a reclosable package 600 (FIG. 6A) having a linear closure region 610 (FIG. 6A). This may make the reclosable package 900 having the non-linear closure region 910 easier to open compared to the reclosable package 600 having the linear closure region 610.

Referring to FIG. 9B, another embodiment of a reclosable package 950 is depicted. The reclosable package 950 includes a non-linear closure region 910 that does not conform to a shape of the outer edge 908. Thus, the closure region 910 may have a non-linear shape that is different than the shape of the outer edge 908. For example, in some embodiments, the outer edge 908 may be linear as shown in FIG. 9B and may extend between the edge seal regions 620 in a straight line, and the closure region 610 may be non-linear. In these embodiments, the closure region 910 may deviate from the contour of the outer edge 908 of the reclosable package 600 such that a distance between the outer edge 908 and the closure region 910 varies from the first end 916 to the second end 918 of the closure region 910.

The reclosable package 950 may include an unsealed region between the outer edge 908 and the closure region 910. The unsealed region may be non-rectangular due to the non-linear shape of the closure region 910 and deviation of the non-linear closure region 910 from the contour of the outer edge 908 of the reclosable package 950. For example, in some embodiments, the unsealed region may include a first unsealed region 952 proximate to the first end 916 of the closure region 910 and a second unsealed region 954 proximate to the second end 918 of the closure region 910. In some embodiments, the first unsealed region 952, the second unsealed region 954, or both may be generally triangular in shape. The unsealed region, such as first unsealed region 952 and second unsealed region 954, may provide areas where the reclosable package 950 may be trimmed after sealing to provide a desired shape to the reclosable package 950.

As previously discussed, the reclosable packages 600, 900, 950, may include the reclosable film 630 in the closure regions 610, 910 of the reclosable packages. The reclosable film 630 may be a multilayer film that includes a composition that may provide the reclose/reopen functionality to the multilayer film. The composition and the multilayer film that may comprise the reclosable film 630 in the previously described reclosable packages 600, 900, 950 will now be described in further detail.

The compositions disclosed herein include an ethylene/α-olefin random copolymer, a styrenic block copolymer, a tackifier, and an oil. The ethylene/α-olefin random copolymer has a density of 0.890 g/cm³ or less, a melting point of 100° C. or less, and a melt index of from 0.2 grams per 10 minutes (g/10 min) to 8.0 g/10 min. The styrenic block copolymer includes from greater than 1 wt. % to less than 50 wt. % units of styrene. The compositions may have an overall melt index (I₂) of from 2 g/10 min to 15 g/10 min. In some embodiments, the compositions may be adhesive compositions. For example, in some embodiments, the compositions may be pressure sensitive adhesive compositions, such as hot melt pressure sensitive adhesives. The compositions may be incorporated into a multilayer film having at least 3 layers. Referring to FIG. 1, Layer A may be a sealant layer, Layer B may include the compositions disclosed herein, and Layer C may include a support material, such as a polyolefin or other support material, for example. Layer B may be positioned proximal to Layer A with a top facial surface of Layer B in adhering contact with a bottom facial surface of Layer A. A top facial surface of Layer C may be in adhering contact with the bottom facial surface of Layer B.

The compositions of Layer B may provide reclose/reopen functionality to the multilayer film. The multilayer film that includes the compositions disclosed herein may exhibit a lower initial cohesive strength which may reduce the amount of force necessary to initially open the multilayer film and packaging made with the multilayer film compared to conventional reclose films. This may make the multilayer film easier to initially open. The multilayer film of the present disclosure may also provide reclose peel adhesion strength after multiple reclose cycles that may be equal to or greater than the reclose peel adhesive of conventional reclose films. The multilayer film that includes the compositions disclosed herein may also maintain acceptable reclose peel adhesion strength over a greater number of reclose cycles compared to conventional reclose films.

Additionally, the compositions may be safe and suitable for use in food packaging applications in some embodiments. Additionally, in some embodiments, the composition does not negatively affect the quality of the packaged contents. For example, some conventional reclosable packages may include compositions that may impart an unpleasant odor to the package contents. In one or more embodiments, composition and multilayer films made with the composition do not affect the aroma, smell, odor, or other olfactory properties of the package contents. The compositions of the present disclosure may include reduced concentrations of styrenic block copolymers compared to conventional reclose films. Therefore, the compositions of the present disclosure and the multilayer films made therewith may provide reclosability to food packaging films without changing the odor or taste of the food packaged in the films in some embodiments.

The ethylene/α-olefin random copolymer of the compositions may be a copolymer of ethylene comonomer and at least one α-olefin comonomer (i.e., alpha olefin comonomer). Suitable α-olefin comonomers may include those containing 3 to 20 carbon atoms (C₃-C₂₀ α-olefins). In some embodiments, the α-olefin comonomer may be a C₃-C₂₀ α-olefin, a C₃-C₁₂ α-olefin, a C₃-C₁₀ α-olefin, a C₃-C₈ α-olefin, a C₄-C₂₀ α-olefin, a C₄-C₁₂ α-olefin, a C₄-C₁₀ α-olefin, or a C₄-C₈ α-olefin. In one or more embodiments, the ethylene/α-olefin random copolymer may be a copolymer of ethylene comonomer and one or more co-monomers selected from propylene, 1-butene, 3-methyl-1-butene, 1-pentene, 3-methyl-1-pentene, 4-methyl-1-pentene, 1-hexene, 1-septene, 1-octene, 1-nonene, 1-decene, 1-dodecene, 1-tetradecene, 1-hexadecene, 1-octadecene, and 1-eicosene. In one or more embodiments, the ethylene/α-olefin random copolymer may be a copolymer of ethylene comonomer and 1-hexene comonomer. In one or more embodiments, the ethylene/α-olefin random copolymer may be an ethylene/octene copolymer that may be made from ethylene comonomer and octene comonomer.

A weight percent of ethylene monomer units in the ethylene/α-olefin random copolymer may be greater than 50 wt. % in one or more embodiments, or greater than or equal to 55 wt. % in other embodiments, or greater than or equal to 60 wt. % in yet other embodiments, or greater than or equal to 65 wt. % in yet other embodiments. In some embodiments, the ethylene/α-olefin random copolymer may include from greater than 50 wt. % to 70 wt. %, from greater than 50 wt. % to 65 wt. %, from greater than 50 wt. % to 60 wt. %, from 55 wt. % to 70 wt. %, from 55 wt. % to 65 wt. %, from 55 wt. % to 60 wt. %, from 60 wt. % to 70 wt. %, from 60 wt. % to 65 wt. %, or from 65 wt. % to 70 wt. % ethylene monomer units. Conversely, a weight percent of the α-olefin comonomer in the first polyethylene resin may be less than 50 wt. % in one or more embodiments, or less than or equal to 45 wt. % in other embodiments, or less than or equal to 40 wt. % in yet other embodiments, or less than or equal to 35 wt. % in yet other embodiments.

The ethylene/α-olefin random copolymer may have a density of less than or equal to 0.890 grams per centimeter cubed (g/cm³). In some embodiments, the ethylene/α-olefin random copolymer may have a density that is less than or equal to 0.880 g/cm³, or even less than 0.87 g/cm³. The density of the ethylene/α-olefin random copolymer is measured in accordance with ASTM D792. In one or more embodiments, the ethylene/α-olefin random copolymer may have a density of from 0.850 g/cm³ to 0.890 g/cm³. In one or more embodiments, the ethylene/α-olefin random copolymer may have a density of from 0.850 g/cm³ to 0.880 g/cm³, from 0.850 g/cm³ to 0.870 g/cm³, from 0.860 g/cm³ to 0.890 g/cm³, or 0.860 g/cm³ to 0.880 g/cm³.

The ethylene/α-olefin random copolymer may have a melting point of less than or equal to 100 degrees Celsius (° C.). For example, in some embodiments, the ethylene/α-olefin random copolymer may have a melting point of less than or equal to 95° C., less than or equal to 90° C., less than or equal to 80° C., or even less than or equal to 75° C. In some embodiments, the ethylene/α-olefin random copolymer may have a melting point of greater than room temperature, such as greater than or equal to 30° C. or even greater than or equal to 40° C. In some embodiments, the ethylene/α-olefin random copolymer may have a melting point of from 30° C. to 100° C., from 30° C. to 95° C., from 30° C. to 90° C., from 30° C. to 80° C., from 30° C. to 75° C., from 40° C. to 100° C., from 40° C. to 95° C., from 40° C. to 90° C., from 40° C. to 80° C., or from 40° C. to 75° C.

The ethylene/α-olefin random copolymer may have a melt index (I₂), which is measured according to ASTM D1238 at 190° C. and 2.16 kg load, of from 0.2 grams per 10 minutes (g/10 min) to 8.0 g/10 min, from 0.2 g/10 min to 5.0 g/10 min, from 0.2 g/10 min to 3.0 g/10 min, from 0.2 g/10 min to 1.5 g/10 min, from 0.2 g/10 min to 1.0 g/10 min, from 0.5 g/10 min to 8.0 g/10 min, from 0.5 g/10 min to 5.0 g/10 min, from 0.5 g/10 min to 3.0 g/10 min, from 0.5 g/10 min to 1.5 g/10 min, from 0.5 g/10 min to 1.0 g/10 min, from 1.0 g/10 min to 8.0 g/10 min, from 1.0 g/10 min to 5.0 g/10 min, from 1.0 g/10 min to 3.0 g/10 min, or from 3.0 g/10 min to 8.0 g/10 min. In one or more embodiments, the ethylene/α-olefin random copolymer may have a melt index (I₂) of from 0.2 g/10 min to 8.0 g/10 min. In one or more other embodiments, the ethylene/α-olefin random copolymer may have a melt index (I₂) of from 0.5 g/10 min to 1.5 g/10 min.

The ethylene/α-olefin random copolymer may have a molecular weight distribution (MWD or Mw/Mn) of from 1.0 to 3.5, from 1.0 to 3.0, from 1.0 to 2.5, from 1.0 to 2.2, from 1.0 to 2.0, from 1.3 to 3.5, from 1.3 to 3.0, from 1.3 to 2.5, from 1.3 to 2.2, from 1.3 to 2.0, from 1.7 to 3.5, from 1.7 to 3.0, from 1.7 to 2.5, from 1.7 to 2.2, or from 1.7 to 2.0. In one or more embodiments, the ethylene/α-olefin random copolymer may have a MWD of from 1.0 to 3.5. Mw is the weight average molecular weight and Mn is the number average molecular weight, both of which may be measured by gel permeation chromatography (GPC).

The dynamic melt viscosity of the ethylene/α-olefin random copolymer may be measured using Dynamic Mechanical Spectroscopy (DMS), which is described subsequently in this disclosure. In some embodiments, the ethylene/α-olefin random copolymer may have a ratio of the dynamic melt viscosity at 0.1 radians per second to the dynamic melt viscosity at 100 radians per second of less than or equal to 20 at a temperature of 110° C. as determined by DMS. In some embodiments, the ethylene/α-olefin random copolymer may have a ratio of the dynamic melt viscosity at 0.1 radians per second to the dynamic melt viscosity at 100 radians per second of less than or equal to 15 at a temperature of 130° C. as determined by DMS. In some embodiments, the ethylene/α-olefin random copolymer may have a ratio of the dynamic melt viscosity at 0.1 radians per second to the dynamic melt viscosity at 100 radians per second of less than or equal to 10 at a temperature of 150° C. as determined by DMS.

The ethylene/α-olefin random copolymer may be made by gas-phase, solution-phase, or slurry polymerization processes, or any combination thereof, using any type of reactor or reactor configuration known in the art, e.g., fluidized bed gas phase reactors, loop reactors, continuous stirred tank reactors, batch reactors in parallel, series, and/or any combinations thereof. In some embodiments, gas or slurry phase reactors are used. In some embodiments, the ethylene/α-olefin random copolymer is made in a gas-phase or slurry process such as that described in U.S. Pat. No. 8,497,330, which is herein incorporated by reference in its entirety. The ethylene/α-olefin random copolymer may also be made by a high pressure, free-radical polymerization process. Methods for preparing the ethylene/α-olefin random copolymer by high pressure, free radical polymerization can be found in U.S. 2004/0054097, which is herein incorporated by reference in its entirety, and can be carried out in an autoclave or tubular reactor as well as any combination thereof. Details and examples of a solution polymerization of ethylene monomer and one or more α-olefin comonomers in the presence of a Ziegler-Natta catalyst are disclosed in U.S. Pat. Nos. 4,076,698 and 5,844,045, which are incorporated by reference herein in their entirety. The catalysts used to make the ethylene/α-olefin random copolymer described herein may include Ziegler-Natta, metallocene, constrained geometry, single site catalysts, or chromium-based catalysts.

Exemplary suitable ethylene/α-olefin random copolymers may include, but may not be limited to, AFFINITY™ EG 8100 ethylene/α-olefin random copolymer and ENGAGE™ 8842 ethylene/α-olefin copolymer supplied by The Dow Chemical Company, Midland, Mich.

The compositions disclosed herein may include from 30 wt. % to 65 wt. % ethylene/α-olefin random copolymer based on the total weight of the composition. For example, in some embodiments, the compositions may include from 30 wt. % to 55 wt. %, from 33 wt. % to 65 wt. %, or from 33 wt. % to 55 wt. % ethylene/α-olefin random copolymer based on the total weight of the composition.

As previously discussed, the compositions include a styrenic block copolymer. The styrenic block copolymer may include from greater than 1 wt. % to less than 50 wt. % styrene. In some embodiments, the styrenic block copolymer may include from 10 wt. % styrene to less than 50 wt. % styrene. The styrene monomer may be styrene or a styrene derivative, such as alpha-methyl styrene, 4-methylstyrene, 3,5-diethylstyrene, 2-ethyl-4-benzylstyrene, 4-phenylstyrene, or mixtures thereof. In one or more embodiments, the styrene monomer is styrene. Various olefin or diolefin (diene) comonomers are contemplated as suitable for polymerizing with the styrene. The olefin comonomer may comprise C₃-C₂₀ α-olefins. The diolefin comonomers may include various C₄-C₂₀ olefins such as 1,3-butadiene, 1,3-cyclohexadiene, isoprene, 1,3-pentadiene, 1,3-hexadiene, 2,3-dimethyl-1,3-butadiene, 2-ethyl-1,3-butadiene, 2-methyl-1,3 pentadiene, 3-methyl-1,3-pentadiene, 4-methyl-1,3-pentadiene, and 2,4-hexadiene, or combinations thereof.

Examples of suitable styrenic block copolymers may include, but are not limited to, styrene-isoprene-styrene block copolymers (SIS), styrene-butadiene-styrene block copolymers (SBS), styrene-ethylene/butylene-styrene block copolymers (SEBS), styrene-isobutylene-styrene block copolymers (SIBS), styrene-ethylene-propylene-styrene block copolymers (SEPS), and mixtures thereof. Examples of styrenic block copolymers may include, but are not limited to, materials commercially available under the tradename “KRATON” such as KRATON D1161, KRATON D1118, KRATON G1657, and the like, available from Kraton Corp., Houston, Tex. or materials commercially available under the trade name “Vector” such as 4113A, 4114A, 4213A, and the like, available from Dexco Polymers, Houston, Tex.

The styrenic block copolymer includes less than 50 wt. % styrene. For example, in some embodiments, the stryrenic block polymer may include less than or equal to 45 wt. %, less than or equal to 40 wt. %, less than or equal to 35 wt. %, less than or equal to 30 wt. %, or even less than or equal to 25 wt. % styrene. In some embodiments, the styrenic block copolymer may have from greater than or equal to 1 wt. % to less than 50 wt. % styrene. In other embodiments, the styrenic block copolymer may have from 5 wt. % to less than 50 wt. %, from 10 wt. % to less than 50 wt. %, from 15 wt. % to less than 50 wt. %, from 20 wt. % to less than 50 wt. %, from 1 wt. % to 45 wt. %, from 1 wt. % to 40 wt. %, from 1 wt. % to 35 wt. %, from 1 wt. % to 30 wt. %, from 1 wt. % to 25 wt. %, from 5 wt. % to less than 50 wt. %, from 5 wt. % to 45 wt. %, from 5 wt. % to 40 wt. %, from 5 wt. % to 35 wt. %, from 5 wt. % to 30 wt. %, from 5 wt. % to 25 wt. %, from 10 wt. % less than 50 wt. %, from 10 wt. % to 45 wt. %, from 10 wt. % to 40 wt. %, from 10 wt. % to 35 wt. %, from 10 wt. % to 30 wt. %, from 10 wt. % to 25 wt. %, from 15 wt. % to less than 50 wt. %, from 15 wt. % to 45 wt. %, from 15 wt. % to 40 wt. %, from 15 wt. % to 35 wt. %, from 15 wt. % to 30 wt. %, or from 15 wt. % to 25 wt. % styrene. In some embodiments, the styrenic block copolymer including less than 50 wt. % styrene may include an amount of non-styrenic copolymer that is sufficient to interact with the tackifier. In some embodiments, the styrenic block copolymer may be SIS and the styrenic block copolymer may include from 15 wt. % to 25 wt. % styrene. In other embodiments, the styrenic block copolymer may be SIS and may include from 20 wt. % to 25 wt. % styrene.

The compositions disclosed herein may include from 10 wt. % to 35 wt. % styrenic block copolymer based on the total weight of the composition. For example, in some embodiments, the compositions may include from 10 wt. % to 30 wt. % styrenic block copolymer based on the total weight of the composition.

The tackifier may be a resin added to the compositions disclosed herein to reduce the modulus and increase the surface adhesion of the compositions compared to the compositions without the tackifier. In some embodiments, the tackifier may be a hydrocarbon tackifier. The tackifier may include, but is not limited to, non-hydrogenated aliphatic C₅ (five carbon atoms) resins, hydrogenated aliphatic C₅ resins, aromatic modified C₅ resins, terpene resin, hydrogenated C₉ resins, or combinations thereof. In some embodiments, the tackifier may be selected from the group consisting of a non-hydrogenated aliphatic C₅ resin and a hydrogenated aliphatic C₅ resin. In some embodiments, the composition may include a plurality of tackifiers.

In some embodiments, the tackifier may have a density from 0.92 g/cm³ to 1.06 g/cm³. The tackifier may exhibit a Ring and Ball softening temperature of from 80° C. to 140° C., from 85° C. to 130° C., from 90° C. to 120° C., from 90° C. to 110° C., or from 91° to 100° C. The Ring and Ball softening temperature may be measured in accordance with ASTM E 28. In some embodiments, the tackifier may exhibit a melt viscosity of less than 1000 Pascal second (Pa-s) at 175° C. For example, in other embodiments, the tackifier may exhibit a melt viscosity of less than or equal to 500 Pa-s, less than or equal to 200 Pa-s, less than or equal to 100 Pa-s, or even less than or equal to 50 Pa-s at 175° C. Further, in some embodiments, the tackifier may exhibit a melt viscosity greater than or equal to 1 Pa-s or greater than or equal to 5 Pa-s at 175° C. In a some embodiments, the tackifier may exhibit a melt viscosity from 1 Pa-s to less than 100 Pa-s, or to less than 50 Pa-s at 175° C. The melt viscosity of the tackifier may be determined using dynamic mechanical spectroscopy (DMS).

The C₅ resin for a “C₅ tackifier” may be obtained from C₅ feedstocks such as pentenes and piperylene. The terpene resin for a tackifier may be based on pinene and d-limonene feedstocks. Examples of suitable tackifiers may include, but are not limited to, tackifiers sold under the tradename PICCOTAC, REGALITE, REGALREZ, and PICCOLYTE, such as PICCOTAC 1100, PICCOTAC 1095, REGALITE R1090, and REGALREZ 11126, available from The Eastman Chemical Company, and PICCOLYTE F-105 from PINOVA.

The compositions disclosed herein may include from 20 wt. % to 40 wt. % tackifier. In some embodiments, the compositions may have from 20 wt. % to 35 wt. %, from 20 wt. % to 30 wt. %, from 25 wt. % to 40 wt. %, from 25 wt. % to 35 wt. %, or from 25 wt. % to 30 wt. % tackifier based on the total weight of the composition.

As previously discussed, the compositions disclosed herein may also include an oil. In some embodiments, the oil may include greater than 95 mole % aliphatic carbon compounds. In some embodiments, the oil may exhibit a glass transition temperature for the amorphous portion of the oil that is less than −70° C. In some embodiments, the oil can be a mineral oil. Examples of suitable oils may include, but are not limited to, mineral oil sold under the tradenames HYDROBRITE 550 (Sonneborn), PARALUX 6001 (Chevron), KAYDOL (Sonneborn), BRITOL 50T (Sonneborn), CLARION 200 (Citgo), CLARION 500 (Citgo), or combinations thereof. In some embodiments, the oil may comprise a combination or two or more oils described herein. The compositions disclosed herein may include from greater than 0 wt. % to 8 wt. % oil. For example, in some embodiments, the compositions may include from greater than 0 wt. % to 7 wt. %, from 3 wt. % to 8 wt. %, from 3 wt. % to 7 wt. %, from 5 wt. % to 8 wt. %, or from 5 wt. % to 7 wt. % oil based on the total weight of the composition.

The present compositions may optionally include one or more additives. Examples of suitable additives may include, but are not limited to, antioxidants, ultraviolet absorbers, antistatic agents, pigments, viscosity modifiers, anti-block agents, release agents, fillers, coefficient of friction (COF) modifiers, induction heating particles, odor modifiers/absorbents, and any combination thereof. In an embodiment, the compositions further comprise one or more additional polymers. Additional polymers include, but are not limited to, ethylene-based polymers and propylene-based polymers.

In some embodiments, the compositions disclosed herein may include from 30 wt. % to 65 wt. % ethylene/α-olefin random copolymer, from 10 wt. % to 35 wt. % styrenic block copolymer, from 20 wt. % to 40 wt. % tackifier, and from greater than 0 wt. % to 8 wt. % oil. In other embodiments, the compositions may include from 33 wt. % to 55 wt. % ethylene/α-olefin random copolymer, from 10 wt. % to 30 wt. % styrenic block copolymer, from 25 wt. % to 30 wt. % tackifier, and from 5 wt. % to 7 wt. % oil.

In some embodiments, the compositions may have an overall density of less than or equal to 0.930 g/cm³, or less than or equal to 0.920 g/cm³. In some embodiments, the compositions may have an overall density of from 0.880 g/cm³ to 0.930 g/cm³, from 0.880 g/cm³ to 0.920 g/cm³, from 0.890 g/cm³ to 0.930 g/cm³, or from 0.89 g/cm³ to 0.92 g/cm³.

In some embodiments, the compositions may exhibit an overall melt index (I₂) of from 2 grams per 10 minutes (g/10 min) to 15 g/10 min. For example, in some embodiments, the compositions may exhibit an overall melt index (I₂) of from 2 g/10 min to 14 g/10 min, from 2 g/10 min to 12 g/10 min, from 2 g/10 min to 10 g/10 min, from 3 g/10 min to 15 g/10 min, from 3 g/10 min to 14 g/10 min, from 3 g/10 min to 12 g/10 min, from 3 g/10 min to 10 g/10 min, from 5 g/10 min to 15 g/10 min, from 5 g/10 min to 14 g/10 min, from 5 g/10 min to 12 g/10 min, from 5 g/10 min to 10 g/10 min, from 7 g/10 min to 15 g/10 min, from 7 g/10 min to 14 g/10 min, from 7 g/10 min to 12 g/10 min, or from 7 g/10 min to 10 g/10 min. The overall melt index (I₂) is determined according to ASTM D1238 at 190° C. and 2.16 kg load.

The dynamic melt viscosity may be determined using Dynamic Mechanical Spectroscopy (DMS) at a various testing temperatures and testing frequency. The compositions may exhibit a dynamic melt viscosity of from 1,000 Pa-s to 1,400 Pa-s measured using DMS at a temperature of 190° C. and a frequency of 1 Hz. The compositions may exhibit a dynamic melt viscosity of from 3,200 Pa-s to 4,000 Pa-s measured using DMS at a temperature of 150° C. and a frequency of 1 Hz. The compositions may exhibit a dynamic melt viscosity of from 7,400 Pa-s to 7,800 Pa-s measured using DMS at a temperature of 130° C. and a frequency of 1 Hz. The compositions may exhibit a dynamic melt viscosity of from 12,400 Pa-s to 17,200 Pa-s measured using DMS at a temperature of 110° C. and a frequency of 1 Hz.

In some embodiments, the compositions disclosed herein may exhibit a melt temperature of less than or equal to 100° C., less than or equal to 90° C., or even less than or equal to 80° C. In some embodiments, the compositions may exhibit a melt temperature of from 60° C. to 100° C., from 60° C. to 90° C., from 60° C. to 80° C., from 70° C. to 100° C., or from 70° C. to 90° C. In some embodiments, the compositions may exhibit no melting peaks above 100° C.

The compositions may exhibit an initial internal cohesion force of less than or equal to 40 newtons/inch (N/in), less than or equal to 37 N/in, less than 35 N/in, or even less than 30 N/in after being heat sealed at a heat sealing temperature of 150° C. The initial internal cohesion force of the compositions may be determined according to the test method for peel strength described herein. In some embodiments, the compositions may exhibit an initial internal cohesion force of from 25 N/in to 40 N/in, from 25 N/in to 37 N/in, from 25 N/in to 35 N/in, from 27 N/in to 40 N/in, from 27 N/in to 37 N/in, from 27 N/in to 35 N/in, from 30 N/in to 40 N/in, from 30 N/in to 37 N/in, or from 30 N/in to 35 N/in after being heat sealed at a heat sealing temperature of 130° C.

In some embodiments, the compositions may exhibit a reclose peel adhesion force of greater than or equal to 1.0 N/in after being heat sealed at a heat seal temperature of 150° C., initially opened, and after experiencing at least 4 reclose-reopen cycles. In some embodiments, the compositions may exhibit a reclose peel adhesion force of greater than or equal to 1.5 N/in, greater than or equal to 2.0 N/in, or even greater than 2.5 N/in after being heat sealed at a heat seal temperature of 150° C., initially opened, and after experiencing at least 4 reclose-reopen cycles. In some embodiments, the compositions may exhibit a reclose peel adhesion force of from 2.0 N/in to 10.0 N/in, from 2.0 N/in to 7.0 N/in, from 2.0 N/in to 5.0 N/in, from 2.5 N/in to 10.0 N/in, from 2.5 N/in to 7.0 N/in, or from 2.5 N/in to 5.0 N/in after being heat sealed at a heat seal temperature of 150° C., initially opened, and after experiencing at least 4 reclose-reopen cycles.

The compositions disclosed herein may be compounded using a single stage twin-screw extrusion process or any other conventional blending or compounding process.

The compositions disclosed herein may be incorporated into a multilayer film, which may provide reclose functionality to packaging made from the multilayer film. The multilayer film may include at least three layers: a sealing layer forming a facial surface of the multilayer film, a reclose layer in adhering contact with the sealing layer, and at least one supplemental layer in adhering contact with the reclose layer. The sealing layer may seal the multilayer film to a substrate, such as a surface of a container, another flexible film, or to itself, for example. The reclose layer, once activated by exerting an initial opening force on the multilayer film, may provide reclose/reopen functionality to the multilayer film. At least one supplemental layer may provide structural support to the multilayer film or may provide an additional sealing layer.

Referring to FIG. 1, the multilayer film 100 is illustrated that includes at least three layers: Layer A, Layer B, and Layer C. The multilayer film 100 will be described relative to an embodiment having three layers; however, the multilayer film may have more than three layers, such as 4, 5, 6, 7, 8, or more than 8 layers. For example, referring to FIG. 2, the multilayer film may have 4 layers: Layer A, Layer B, Layer C, and Layer D. Multilayer films with more than 4 layers are also contemplated.

Referring again to FIG. 1, the multilayer film 100 may have a film top facial surface 102 and a film bottom facial surface 104. Similarly, each of the layers A, B, and C may have opposing facial surfaces, such as a top facial surface and a bottom facial surface. As used in this disclosure, the term “top” refers to the facial surface of the multilayer oriented toward the Layer A side of the multilayer film 100, and the term “bottom” refers to the opposite side of the multilayer film 100 oriented away from the Layer A side of the multilayer film 100.

Layer A may have a top facial surface 112 and a bottom facial surface 114. The top facial surface 112 of Layer A may be the film top facial surface 102 of the multilayer film 100. The bottom facial surface 114 of Layer A may be in adhering contact with the top facial surface 122 of Layer B.

Layer A is a sealing layer that includes a sealing composition capable of sealing the film top facial surface 102 of the multilayer film 100 to a surface of a substrate or to itself. For example, in some embodiments, the sealing composition may be a heat sealing composition. In some embodiments, the sealing composition may be capable of hermitically sealing the film top facial surface 102 of the multilayer film 100 to a surface of a substrate or to itself. In some embodiments, the sealing composition may include a polyolefin. For example, in some embodiments, the sealing composition of Layer A may include at least one of low density polyethylene (LDPE), linear low density polyethylene (LLDPE), ultra-low density polyethylene (ULDPE), ethylene vinyl acetate (EVA), ionomers, other sealing composition, or combinations of these. Examples of sealing compositions may include, but are not limited to, AFFINITY™ polyolefin elastomer supplied by The Dow Chemical Company, Midland, Mich. In some embodiments, Layer A does not include the composition previously described in this disclosure. The sealing composition of Layer A has an internal cohesive strength greater than the internal cohesive strength of the composition of Layer B.

The sealing composition of Layer A may have an internal cohesion strength that is greater than the internal cohesion strength of the composition of Layer B. During initial opening of the multilayer film 100, such as when opening a resealable package made with the multilayer film 100, the initial opening force causes the sealing composition of Layer A to fail in a direction generally perpendicular to the multilayer film 100. Failure of the sealing composition of Layer A may enable the composition of Layer B to cohesively fail in a direction generally parallel to the multilayer film 100 to activate the reclose functionality. Therefore, the internal cohesion strength of Layer A may be low enough so that the magnitude of the opening force needed to initially open the multilayer film 100 and activate the reclose/reopen functionality is not excessive.

Referring to FIG. 1, Layer B includes the top facial surface 122 and a bottom facial surface 124. The top facial surface 122 of Layer B may be in adhering contact with the bottom facial surface 114 of Layer A. Additionally, the bottom facial surface 124 of Layer B may be in adhering contact with a top facial surface 132 of Layer C. Thus, Layer B is positioned adjacent to Layer A and in adhering contact with Layer B, and Layer B is disposed between Layer A and Layer C. Layer B comprises the compositions previously described in this disclosure that include the ethylene/α-olefin random copolymer, styrenic block copolymer, tackifier, and oil.

Layer C includes the top facial surface 132 and a bottom facial surface 134. As previously discussed, the top facial surface 132 of Layer C may be in adhering contact with the bottom facial surface 124 of Layer B. In some embodiments, the bottom facial surface 134 of Layer C may comprise the film bottom facial surface 104 of the multilayer film 100, such as when the multilayer film 100 includes three layers. Alternatively, in other embodiments, the bottom facial surface 134 of Layer C may be in adhering contact with a top facial surface of a subsequent layer. For example, referring to FIG. 2, the bottom facial surface 134 of Layer C may be in adhering contact with a top facial surface 142 of Layer D.

In some embodiments, Layer C may be a structural layer that may provide strength and stiffness to the multilayer film 100. In some embodiments, Layer C may include a polymer or copolymer comprising at least an ethylene monomer, such as, but not limited to high density polyethylene (HDPE), medium density polyethylene (MDPE), low density polyethylene (LDPE), linear low density polyethylene (LLDPE), very low density polyethylene (VLDPE), or combinations of these. For example, in some embodiments, Layer C may include LLDPE. In other embodiments, Layer C may include other polymer film materials, such as nylon, polypropylene, polyesters such as polyethylene terephthalate (PET) for example, polyvinyl chloride, other thermoplastic polymers, or combinations of these. In some embodiments, Layer C may include additional structural materials, such as nylon for example. In other embodiments, Layer C may be a sealant layer that includes any of the sealant compositions previously discussed in relation to Layer A.

In some embodiments, the multilayer film 100 may be a flexible film, which may enable the multilayer film 100 to conform its shape to seal to various substrates and substrate surfaces.

Additional supplemental layers may be added to the bottom facial surface 134 of Layer C to impart any of a number of properties to the multilayer film. For Example, referring to FIG. 2, a multilayer film 200 that includes four layers is schematically depicted. As shown, multilayer film 200 may include Layer A, Layer B, Layer C, and Layer D. Layer A may again be the sealing layer, and Layer B may be the reclose layer in adhering contact with the sealing layer (Layer A). The multilayer film 200 depicted in FIG. 2 includes at least two supplemental layers; Layer C and Layer D. Layer C may have the top facial surface 132 in adhering contact with the bottom facial surface 124 of Layer B. The bottom facial surface 134 of Layer C may be in adhering contact with the top facial surface 142 of Layer D. In some embodiments, the bottom facial surface 144 of Layer D may be the film bottom facial surface 104 of the multilayer film 200. Alternatively, in other embodiments, the bottom facial surface 144 of Layer D may be in adhering contact with the top facial surface of another supplemental layer.

Each of the supplemental layers, such as Layers C and D and other supplemental layers, may include different materials or combinations of materials that provide different properties to the multilayer film 200, such as structural support, insulating properties, moisture resistance, chemical resistance, tear or puncture resistance, optical properties, sealing capability, gas permeability or impermeability properties, friction resistance, other properties, or combinations of these. For example, in some embodiments, Layer C may include materials that provide structural support to the multilayer film, and Layer D may include a sealing composition, such as the sealing compositions previously described for Layer A, to enable sealing of the film bottom facial surface 104 of the multilayer film 200 to a second substrate. Layers C and D, as well as other supplemental layers included to the bottom portion of the multilayer film 200 may provide a plurality of other functionalities to the multilayer film 200.

Referring to FIGS. 1 and 2, each of the plurality of layers, such as Layer A, Layer B, Layer C, and any additional supplemental layers, may be coextruded to form the multilayer films 100, 200. For example, in some embodiments, the multilayer films 100, 200 may be produced using a blown film process. Alternatively, in other embodiments, the multilayer films 100, 200 may be produced using cast film processes. Other conventional processes for producing multilayer films may also be employed to produce the multilayer films 100, 200.

Referring to FIGS. 3A-3C, operation of the multilayer film 100 will be described. The multilayer film 100 may be initially sealed to a surface 152 of a substrate 150. The substrate 150 may be a rigid substrate, such as a rigid container made from plastic, metal, glass, ceramic, coated or uncoated cardboard (e.g., fiberboard, paperboard or other rigid structure made from wood pulp), other rigid material, or combinations of these. Alternatively, the substrate 150 may be a non-rigid or flexible substrate, such as a polymer film, metal foil, paper, natural or synthetic fabric, other flexible substrate, or combinations of these. For example, in some embodiments, the substrate 150 may include another multilayer polymer film. Is some embodiments, the substrate 150 may be the multilayer film 100 itself, such as by folding the multilayer film 100 and sealing the multilayer film 100 to itself or by providing two separate sheets or webs of the multilayer film 100. In some embodiments, the film top facial surface 102 in one region of the multilayer film 100 may be in adhering contact with the film top facial surface 102 in another region of the multilayer film 100 or with the film top facial surface 102 of another sheet of the multilayer film 102. Alternatively, the film top facial surface 102 in one region of the multilayer film 100 may be in adhering contact with the film bottom facial surface 104 in another region of the multilayer film 102.

Referring to FIG. 3A, the multilayer film 100 may be sealed to the surface 152 of the substrate 150 by contacting the top facial surface 112 of Layer A with a surface 152 of the substrate 150 and applying heat, pressure, or a combination of heat and pressure to the multilayer film 100 to seal the Layer A, which is the sealing layer of the multilayer film 100, to the surface 152 of the substrate 150. In some embodiments, Layer A of the multilayer film 100 may be heat sealed to the substrate 150. Heat sealing may be accomplished by conventional heat sealing processes which may be operated at heat sealing temperatures of greater than about 130° C. For example, in some embodiments, Layer A of the multilayer film 100 may be heat sealed to the surface 152 of the substrate 150 at a heat sealing temperature of from 100° C. to 180° C. In some embodiments, the heat sealing temperature may be from 100° C. to 160° C., from 100° C. to 150° C., from 120° C. to 180° C., from 120° C. to 160° C., from 120° C. to 150° C., from 130° C. to 180° C., from 130° C. to 160° C., or from 130° C. to 150° C.

In some embodiments, only a portion of Layer A of the multilayer film 100 is sealed to the surface 152 of the substrate 150 to form a sealed region 154. The portions of the multilayer film 100 in which Layer A is not sealed to the surface 152 of the substrate 150 may define an unsealed region 156 of the multilayer film 100. In the unsealed region 156, Layer A of the multilayer film 100 is not sealed to the surface 152 of the substrate 150 and may be free to move in a direction normal to the surface 152 of the substrate 150 so that Layer A of the multilayer film 100 is spaced apart from the substrate 150 in the unsealed region 156. For example, in some embodiments, in the unsealed region 156, the multilayer film 100 may be spaced apart from the substrate 150 to define a volume between the multilayer film 100 and the substrate 150. Alternatively or additionally, in some embodiments, the unsealed region 156 may provide a tab 158 that may enable a force to be exerted on the multilayer film 100 relative to the substrate 150.

In some embodiments, the sealed regions 154 may exhibit a seal integrity sufficient to prevent passage of particulates between the multilayer film 100 and the substrate 150 in the sealed region 154. In other embodiments, seal integrity of the sealed regions 154 may be sufficient to prevent passage of liquids between the multilayer film 100 and the substrate 150 in the sealed region 154. In still other embodiments, seal integrity of the sealed regions 154 may be sufficient to prevent passage of moisture between the multilayer film 100 and the substrate 150 in the sealed region 154. In still other embodiments, seal integrity of the sealed regions 154 may be sufficient to prevent passage of are between the multilayer film 100 and the substrate 150 in the sealed region 154.

Upon sealing the film top facial surface 102 of the multilayer film 100 to the surface 152 of the substrate 150 to form the sealed region 154, a bond strength between the bottom facial surface 114 of Layer A and the top facial surface 122 of Layer B may be greater than a cohesive strength of the composition of Layer B. Additionally, after sealing, a bond strength between the bottom facial surface 124 of Layer B and the top facial surface 132 of Layer C may be also be greater than an internal cohesion strength of the composition of Layer B. After sealing, the bond strength of the top facial surface 112 of Layer A to the surface 152 of the substrate 150 may be greater than an internal cohesion strength of the composition of Layer B. Therefore, the sealing composition of Layer A does not provide reclose functionality to the multilayer film 100. Once sealed to the substrate 150, the multilayer film 100 does not exhibit reclose functionality until after an initial opening force is applied to the multilayer film 100 to separate a portion of the multilayer film 100 from the substrate 150.

Referring to FIG. 3B, the reclose functionality of the multilayer film 100 may be activated by applying an initial opening force F1 on the multilayer film 100. The initial opening force F1 may be applied in a direction generally perpendicular to the film top facial surface 102 of the multilayer film 100. The initial opening force F1 may be greater than a threshold force, at which separation of the multilayer film 100 occurs to activate the reclose functionality. The initial opening force F1 may be sufficient to cause Layer A to fail at an interface 160 between the sealed region 154 and the unsealed region 156 of the multilayer film 100. In some embodiments, the initial opening force F1 for the multilayer film 100 may be less than or equal to about 40 newtons/inch (N/in), less than less than or equal to 37 N/in, less than or equal to 35 N/in, or even less than or equal to 30 N/in after being heat sealed at a heat sealing temperature of 150° C. The initial opening force F1 may be determined according to the Peel Adhesion Test described herein. The initial opening force F1 of the multilayer film may be determined according to the test method for peel strength described herein at the heat sealing temperature of 130° C. In some embodiments, the initial opening force F1 for the multilayer film 100 may be from 25 N/in to 40 N/in, from 25 N/in to 37 N/in, from 25 N/in to 35 N/in, from 27 N/in to 40 N/in, from 27 N/in to 37 N/in, from 27 N/in to 35 N/in, from 30 N/in to 40 N/in, from 30 N/in to 37 N/in, or from 30 N/in to 35 N/in after the multilayer film is heat sealed at a heat sealing temperature of 130° C.

At an initial opening force F1 greater than the threshold force, Layer A ruptures at an interface 160 of the sealed region 154 and the unsealed region 156. Layer A may rupture in a direction from the bottom facial surface 114 to the top facial surface 112 of Layer A (e.g., generally perpendicular to the film top facial surface 102 or in the +/−Z direction of the coordinate axis of FIG. 3B). The internal cohesion strength of the composition of Layer B is less than the initial opening force and less than the bond strengths between the top facial surface 122 of Layer B and the bottom facial surface 114 of Layer A, and between the bottom facial surface 124 of Layer B and the top facial surface 132 of Layer C. Thus, once Layer A ruptures at the interface 160 of the sealed region 154 and the unsealed region 156, Layer B in the sealed region 154 cohesively fails in a direction generally parallel to the film top facial surface 102. Cohesive failure of Layer A results in a first portion 162 of the composition of Layer B coupled to the bottom facial surface 114 of Layer A and a second portion 164 of the composition of Layer B coupled to the top facial surface 132 of Layer C. Thus, in the opened portion of the sealed region 154, the composition of Layer B covers both the top facial surface 132 of Layer C and the bottom facial surface 114 of Layer A. The portion of Layer A in the sealed region 154, including the opened portion of the sealed region 154, remains sealed to the substrate 150 (i.e., the top facial surface 112 of Layer A remains sealed to the surface 152 of the substrate 150 in the sealed region 154, including the opened portion).

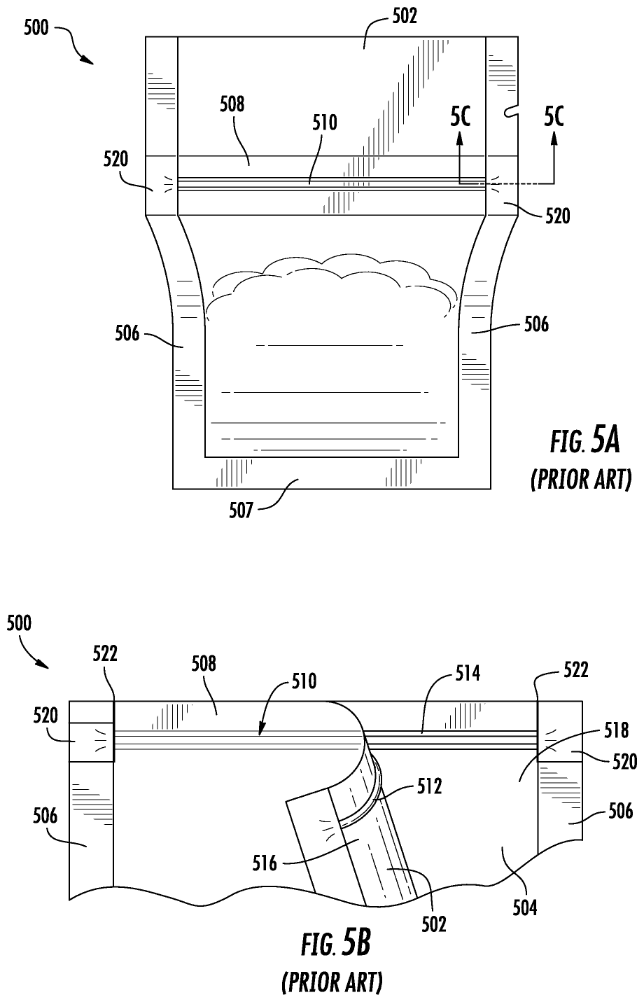

Referring to FIG. 4A, a cross-section of the multilayer film 100 and substrate 150 of FIG. 3A is taken along reference line 4A-4A. In the embodiments schematically represented in FIG. 4A, the sealed region 154 may bounded by the unsealed region 156 on one side of the sealed region 154 and a second unsealed region 157 on the other side of the sealed region. During initial opening, the initial opening force F1 may cause Layer A to rupture at the interface 160 of the sealed region 154 and the unsealed region 156 in a direction generally perpendicular to the film top facial surface 102, as previously described in relation to FIG. 3B. As shown in FIG. 4B, the opening force F1 may cause Layer B to cohesively fail in a direction generally parallel to the film top facial surface 102, as previously described. When cohesive failure of Layer B reaches a second interface 161 between the sealed region 154 and the second unsealed region 157, the initial opening force F1 may cause Layer A to rupture again at the second interface 161 between the sealed region 154 and the second unsealed region 157. At the second interface 161, Layer A may rupture in a direction generally perpendicular to the film top facial surface 102. After initial opening of the multilayer film 100, a portion of Layer A corresponding to the sealed region 154 is separated from the multilayer film 100 and remains coupled to the substrate 150.

Initial opening of the multilayer film 100 activates the reclose functionality of the multilayer film resulting in the first portion 162 of the composition of Layer B on the bottom facial surface 114 of Layer A and the second portion 164 of the composition of Layer B on the top facial surface 132 of Layer C. Referring to FIG. 3C, to reclose the sealed region 154 of the multilayer film 100, the first portion 162 of the composition of Layer B may be returned into contact with the second portion 164 of the composition of Layer B and a reclose pressure F2 may be applied to the multilayer film 100 in the sealed region 154. The reclose pressure F2 may be applied to the multilayer film 100 in a direction generally perpendicular to the film bottom facial surface 104. The reclose pressure F2 may be sufficient to cause the first portion 162 and the second portion 164 of the composition of Layer B to re-adhere to reform Layer B. In some embodiments, the reclose pressure F2 may be less than or equal to 40 N/inch, less than or equal to 30 N/inch, less than or equal to 20 N/inch, or even less than or equal to 10 N/inch.

Applying the reclose pressure F2 to the multilayer film causes the first portion 162 and the second portion 164 of the composition of Layer B to re-adhere. Re-adherence of the first portion 162 and the second portion 164 of the composition to form a contiguous Layer B, may reseal the sealed region 154 of the multilayer film.

Referring to FIG. 3D, after reclosing the multilayer film 100, the multilayer film 100 may be reopened by applying a reopen force F3 to the multilayer film 100. Reopen force F3 may be applied to the multilayer film in a direction generally perpendicular to the film top facial surface 102. The reopen force F3 may be applied by gripping the multilayer film 100 in the unsealed region 156 and pulling the multilayer film 100 away from the substrate 150. Application of the reopen force F3 may cause the composition of Layer B to cohesively fail in a direction parallel to the film top facial surface 102. Again, cohesive failure of the composition of Layer B results in a first portion of the composition coupled to the bottom facial surface 114 of Layer A and a second portion of the composition coupled to the top facial surface 132 of Layer C.

The reopen force F3 may be sufficient to cause the composition of Layer B to cohesively fail. In some embodiments reopen force F3 may be greater than or equal to 1 N/inch, greater than or equal to 1.5 N/in, greater than or equal to 2.0 N/in, greater than or equal to 2.5 N/in, or even greater than or equal to 3 N/in for the multilayer film 100 heat sealed to the substrate 150 at a heat seal temperature of 130° C. The reopen force F3 may be determined according to the Peel Adhesion Test described herein. The multilayer film 100 may be subjected to multiple cycles of reopening and reclosing. After multiple reopen/reclose cycles, the multilayer film 100 may exhibit a reopen force F3 of greater than or equal to 1.5 N/in, greater than or equal to 2.0 N/in, greater than or equal to 2.5 N/in, or even greater than 3.0 N/in. For example, in some embodiments, the multilayer film 100, which is initially heat sealed to the substrate 150 at a heat seal temperature of 130° C., may exhibit a reopen force F3 after at least four reopen/reclose cycles of greater than 2.0 N/in. In some embodiments, the multilayer film 100 may exhibit a reopen force of from 2.0 N/in to 10.0 N/in, from 2.0 N/in to 7.0 N/in, from 2.0 N/in to 5.0 N/in, from 2.5 N/in to 10.0 N/in, from 2.5 N/in to 7.0 N/in, or from 2.5 N/in to 5.0 N/in after being heat sealed at a heat seal temperature of 130° C., initially opened, and after experiencing at least 4 reclose-reopen cycles.

FIGS. 1-9B illustrate only a few examples of reclosable package designs that can incorporate the reclosable film and compositions according to embodiments of the present disclosure. A person of ordinary skill in the art can readily identify other package types, shapes, and sizes in which the reclosable film and composition disclosed herein may be incorporated. For example, the reclosable film and/or compositions may be incorporated into package shapes and sizes for which zippers or other mechanical means have been used to provide reclosability to the package. Additionally, the reclosable films and compositions may be incorporated into a broad range of package types and shapes that include at least one flexible film. Examples of these packaging types may include, but are not limited to tray packaging; pouch packaging such as pillow pouches, vertical form fill and seal (VFFS) packaging, horizontal form fill and seal packages, stand-up pouches, or other pouches; bags; boxes; or other type of packaging. The reclosable films and compositions may be incorporated into primary packaging or secondary packaging, such as overwraps, bags, or other secondary packaging. Other packaging types, shapes and sizes having the reclosable film and/or compositions disclosed herein are also contemplated.

In some embodiments, the reclosable packaging disclosed herein may be used to package food products, beverages, consumer goods, personal care items, or other articles. Food products that may be packaged using the reclosable packaging disclosed herein may include particular food products, such as sugar, spices, flour, coffee, or other particulates; solid food products; such as meats, cheeses, snacks, vegetables, baked goods, pet food, pasta, or other solid food products; liquid food products, such as but not limited to milk, soup, beverages, or other liquid food products; and/or bulk food items such as but not limited to rice, dog food, flour or other grains, or other bulk food items. Consumer goods that may be packaged using the reclosable packaging may include but are not limited to consumer electronics, hardware, toys, sporting goods, plastic utensils, autoparts, batteries, cleaning supplies, software packages, salt, or other consumer goods. The reclosable packages disclosed herein may also be incorporated into post-consumer storage bags, such as food storage bags or freezer bags. A person of ordinary skill in the art can recognize many other potential uses for the reclosable packaging disclosed herein.

### Test Methods

Density

Density is measure in accordance with ASTM D792 and reported in grams/cubic centimeter (g/cc or g/cm³).

Melt Index

Melt index (I₂), is measured in accordance with ASTM D1238-10, under conditions of 190° C. and 2.16 kg of load. The melt index (I₂) is reported in grams eluted per 10 minutes (g/10 min).

Differential Scanning Calorimetry (DSC)

DSC can be used to measure the melting, crystallization, and glass transition behavior of a polymer over a wide range of temperature. The DSC analysis may be performed on a TA Instruments Q1000 DSC, equipped with a refrigerated cooling system (RCS) and an autosampler is used to perform the analysis. During testing, a nitrogen purge gas flow of 50 ml/min is used. Each sample is melt pressed into a thin film at about 175° C. The melted sample is then air-cooled to room temperature (about 25° C.). A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 230° C. and held isothermal for 5 minutes in order to remove its thermal history. Next, the sample is cooled to −90° C. at a 10° C./minute cooling rate and held isothermal at −90° C. for 5 minutes. The sample is then heated to 230° C. (this is the “second heat” ramp) at a 10° C./minute heating rate. The cooling and second heating curves are recorded. The values determined are extrapolated onset of melting, Tm, and extrapolated onset of crystallization, Tc. Heat of fusion (H_{f}) (in Joules per gram), and the calculated % crystallinity for polyethylene samples using the Equation below:

% Crystallinity=((H_{f})/292 (J/g))×100

The heat of fusion (H_{f}) and the peak melting temperature are reported from the second heat curve. Peak crystallization temperature is determined from the cooling curve.

Melting point, Tm, is determined from the DSC heating curve by first drawing the baseline between the start and end of the melting transition. A tangent line is then drawn to the data on the low temperature side of the melting peak. Where this line intersects the baseline is the extrapolated onset of melting (Tm). This is as described in B. Wunderlich in Thermal Characterization of Polymeric Materials, 2^{nd} edition, Academic Press, 1997, E. Turi ed., pgs 277 and 278. The crystallization temperature, Tc, is determined from a DSC cooling curve as above except the tangent line is drawn on the high temperature side of the crystallization peak. Where this tangent intersects the baseline is the extrapolated onset of crystallization (Tc). Glass transition temperature, Tg, is determined from the DSC heating curve where half the sample has gained the liquid heat capacity as described in B. Wunderlich in Thermal Characterization of Polymeric Materials, 2^{nd} edition, Academic Press, 1997, E. Turi ed., pg 278 and 279. Baselines are drawn from below and above the glass transition region and extrapolated through the Tg region. The temperature at which the sample heat capacity is half-way between these baselines is the Tg.

Dynamic Mechanical Spectroscopy (DMS) for Polymers and Formulations

Dynamic Mechanical Spectroscopy (DMS) is performed on compression molded disks formed in a hot press at 180° C. at 10 MPa pressure for 5 minutes, and then water cooled in the press at 90° C./min. DMS testing is conducted using an Advance Rheometric Expansion System (ARES) controlled strain rheometer equipped with dual cantilever fixtures for torsion testing, which is available from TA Instruments.

For polymer testing, a 1.5 mm plaque is pressed, and cut in a bar of dimensions 32×12 mm (test sample). The test sample is clamped at both ends between fixtures separated by 10 mm (grip separation AL), and subjected to successive temperature steps from −100° C. to 200° C. (5° C. per step). At each temperature, the torsion modulus G′ is measured at an angular frequency of 10 rad/s, the strain amplitude being maintained between 0.1 percent and 4 percent, to ensure that the torque is sufficient and that the measurement remained in the linear regime.

An initial static force of 10 g is maintained (auto-tension mode) to prevent slack in the sample when thermal expansion occurred. As a consequence, the grip separation AL increases with the temperature, particularly above the melting or softening point of the polymer sample. The test stops at the maximum temperature or when the gap between the fixtures reaches 65 mm.

For PSA formulation testing, constant temperature frequency sweeps using a TA Instruments (ARES) equipped with 8 mm parallel plates geometry under a nitrogen purge. Frequency sweeps are performed at 150° C. and 190° C. for all the samples at a gap of 2.0 mm and at a constant strain of 10%. The frequency interval is 0.1 to 100 radians/seconds. The stress response is analyzed in terms of amplitude and phase, from which the storage modulus (G′), loss modulus (G″) and dynamic melt viscosity (eta*, or η*) are calculated.

Constant frequency temperature sweeps are performed using a TA Instruments ARES strain rheometer equipped with 8 mm parallel plates geometry under a nitrogen purge. Temperature sweeps are performed at 1 Hz frequency, from −40° C. to 200° C. for all the samples at a gap of 2.0 mm and at a constant strain of 10%. The frequency interval is 0.1 to 100 radians/seconds. The stress response is analyzed in terms of amplitude and phase, from which the storage modulus (G′), loss modulus (G″) and dynamic melt viscosity (eta*, or η*) are calculated.

Peel Adhesion Test

The adhesion test follows the general framework of PSTC-101 test method A from the Pressure Sensitive Tape Council (PSTC). This is a 180° angle peel, at 305 mm/minute, against some surface of interest. In this case, the film layer adjacent to the adhesive layer, where reclose functionality is designed to exist, is the surface of interest. Flexible film samples are fixed to a stainless steel panel using masking tape [PET/solventless adhesive/core (3 layers)/PSA/sealant/sealant/PSA/core (3 layers)/solventless adhesive/PET/fixed to panel with masking tape at one free end (sealant/PSA/core (3 layers)/solventless adhesive/PET) of the test specimen; the adhesive on the masking tape is in contact with the sealant layer of the free end of the test specimen]. A second piece of masking tape is used to fix the folded end of the test specimen to the panel; here, the tape is placed approximately 10 mm from the fold [masking tape/PET/solventless adhesive/core (3 layers)/PSA/sealant/sealant/PSA/core (3 layers)/solventless adhesive/PET/fixed to panel with masking tape; the adhesive on the masking tape is in contact with the upper PET layer of the folded end of the test specimen.] The other free end of the test specimen is peeled at 180° from the fixed free end of the test specimen, causing a break within the PSA for Examples 1-5 and at the PSA-core interface for Comparative Examples 1 and 2 [Free end: PET/solventless adhesive/core (3 layers)/-BREAK-PSA/sealant/sealant/PSA/core (3 layers)/solventless adhesive/PET-panel], and giving a force value.

An INSTRON 5564, running BLUEHILL 3 software, is used to collect the peel data. All samples are equilibrated to standard conditions, 23° C. and 50% RH. Testing is conducted in standard conditions as well. The peak force is recorded for five test samples of each laminated film, and averaged. After the first peel, the specimen is reclosed using the standard roller conditions given in the PSTC test method for sample lamination. The standard dwell time between rolling/sealing the specimen and testing/peeling the specimen is 20 minutes, but several longer dwells are performed to test the PSA's recovery and are indicated in Table 5 (23° C. and 50% RH). The specimen is reclosed 10 times or until the force could no longer be measured. The adhesion results are shown in Table 5. The PSA failure modes are recorded as “C” meaning cohesive failure through PSA layer and “A” meaning adhesive delamination between PSA and adjacent layer.

### EXAMPLES

The following Examples illustrate various embodiments of the composition and multilayer film described herein. The compositions of the following examples and comparative examples were compounded using a single stage twin-screw extrusion process. The compounding operation is performed on a Century-ZSK-40 45.375 length-to-diameter ratio (L/D) (Eleven Barrels) extruder using one screw design with one oil injector, in barrel 4. The extruder has a maximum screw speed of 1200 rpm. The polymers and the PICCOTAC tackifier were fed into the main feed throat of the extruder. The HYDROBRITE 550 process oil is added through an injection port at barrel 4. The compound is pelletized using an underwater Gala system, which is equipped with a 12 hole (2.362 mm hole diameter) Gala die with 6 holes plugged, and a 4 blade hub cutter. Soap and antifoam were added to the water bath as needed to prevent clumping. The pellets were collected and dusted with 2000 ppm POLYWAX 2000 (available from Baker Hughes), and then dried under nitrogen purge for 24 hours. Screw speed is set at 180 RPM for all the samples. Temperature profile is set as follows: 100° C. (zone 1), 100° C. (zone 2), 180° C. (zone 3), 180° C. (zone 4), 160° C. (zone 5), 160° C. (zone 6), 110° C. (zone 7), 110° C. (zone 8), 90° C. (zone 9), 90° C. (zone 10), and 90° C. (zone 11), with a die temperature of 140° C.

Table 1 below includes properties of commercial polymers used in the Examples that follow.

TABLE 1
Properties of commercial polymers

| | Melt Index | | |
|---|---|---|---|
| | (I₂) g/10 | Density | |
| Material | min | (g/cc) | Supplier |
| INFUSE ™ 9107 | 1.00 | 0.866 | The Dow |
| (olefin block | | | Chemical Company, |
| copolymer) | | | Midland, MI |
| DOW ™ LDPE 5004i | 4.20 | 0.924 | The Dow |
| (LDPE) | | | Chemical Company, |
| | | | Midland, MI |
| DOWLEX ™ NG | 1.00 | 0.935 | The Dow |
| 2038.68G (LLDPE) | | | Chemical Company, |
| | | | Midland, MI |
| ENGAGE ™ 8842 | 1.00 | 0.857 | The Dow |
| (polyolefin plastomer) | | | Chemical Company, |
| | | | Midland, MI |
| VECTOR ® 4113A | 9.20 | 0.920 | Dexco Polymers, |
| (styrene-isoprene | | | Houston, TX |
| triblock copolymer) | | | |
| VECTOR ® 4213A | 12.0 | 0.940 | Dexco Polymers, |
| (SIS triblock/SI | | | Houston, TX |
| diblock copolymer) | | | |
| ELVAX ® 3124 | 7.0 | 0.930 | E.I. du Pont de |
| (ethylene-vinyl | | | Nemours and |
| acetate copolymer w/ | | | Company, Inc. |
| 9 wt. % vinyl acetate) | | | |

### Example 1: Example Composition

A composition according to the present disclosure was made by combining 43.4 wt. % ethylene/α-olefin random copolymer, 20 wt. % styrenic block copolymer, 30 wt. % tackifier, and 6.6 wt. % mineral oil. The ethylene/α-olefin random copolymer was ENGAGE™ 8842. The styrenic block copolymer was VECTOR 4113A styrene-isoprene triblock copolymer, which had a styrene content of 18 wt. %, and a diblock content of 42 wt. %. The tackifier was PICCOTAC 1100 C₅ tackifier available from Eastman Chemical Company. The tackifier has a ring and ball softening point of 100° C. and a Mw of 2900. The mineral oil was HYDROBRITE 550 mineral oil available from Sonneborn and exhibited a density of 0.87 g/cm³ and paraffinic carbon content of about 70 wt. %.

The individual constituents of the composition of Example 1 were compounded according to the previously described single stage twin-screw extrusion process. The composition of Example 1 was then tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Example 1 are provided below in Table 2.

### Comparative Example 2: Comparative Adhesive Composition Formulated with Olefin Block Copolymer

In Comparative Example 2, a comparative adhesive composition was produced using an olefin block copolymer in place of the ethylene/α-olefin random copolymer of Example 1. The composition of Comparative Example 2 included 43.4 wt. % olefin block copolymer, 20 wt. % of the styrenic block copolymer, 30 wt. % tackifier, and 6.6 wt. % mineral oil. The olefin block copolymer was INFUSE™. The styrenic block copolymer, tackifier, and mineral oil in Comparative Example 2 were the same as described above for Example 1.

The individual constituents of Comparative Example 2 were compounded using the previously described single stage twin-screw extrusion process. The composition of Comparative Example 2 was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 2 are provided below in Table 2.

### Comparative Example 3: Comparative Adhesive Composition Formulated with a Lesser Amount of Olefin Block Copolymer

In Comparative Example 3, a comparative adhesive composition was produced using an olefin block copolymer in place of the ethylene/α-olefin random copolymer of Example 1. The composition of Comparative Example 3 included less olefin block copolymer and more styrenic block copolymer compared to the composition of Comparative Example 2.

Comparative Example 3 was prepared to investigate the effect of increasing the amount of the styrenic block copolymer in the adhesive composition.

The composition of Comparative Example 3 included 33.4 wt. % olefin block copolymer, 30 wt. % of the styrenic block copolymer, 30 wt. % tackifier, and 6.6 wt. % mineral oil. The olefin block copolymer was INFUSE™ 9107. The styrenic block copolymer, tackifier, and mineral oil were the same as described above for Example 1.

The individual constituents of Comparative Example 3 were compounded using the previously described single stage twin-screw extrusion process. The composition of Comparative Example 3 was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 3 are provided below in Table 2.

### Comparative Example 4: Commercially Available Adhesive Composition for Reclose Multilayer Films

For Comparative Example 4, a commercially available pressure sensitive adhesive composition marketed as providing reclose capability to multilayer film compositions was obtained. The commercially available composition comprised a styrene-isoprene-styrene block copolymer, hydrocarbon tackifier, and talc. The commercially available composition did not include a polyethylene component, such as a polyethylene/α-olefin copolymer. The commercially available adhesive composition was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 4 are provided below in Table 2.

### Comparative Example 5: Comparative Adhesive Composition Formulated with Styrenic Block Copolymer, Tackifier, and Oil

In Comparative Example 5, a comparative adhesive composition was produced using a styrenic block copolymer without the ethylene/α-olefin random copolymer of Example 1. The composition of Comparative Example 5 included 64.3 wt. % styrenic block copolymer, 30 wt. % tackifier, and 6.6 wt. % mineral oil. The styrenic block copolymer was VECTOR® 4213A SIS triblock/SI diblock copolymer. The tackifier and mineral oil were the same as described above for Example 1.

The individual constituents of Comparative Example 5 were compounded using the previously described single stage twin-screw extrusion process. The composition of Comparative Example 5 was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 5 are provided below in Table 2.

### Comparative Example 6: Comparative Adhesive Composition Formulated with EVA and Styrenic Block Copolymer

In Comparative Example 6, a comparative adhesive composition was produced using an ethylene-vinyl acetate copolymer (EVA) in place of the ethylene/α-olefin random copolymer of Example 1. The composition of Comparative Example 6 included 20.0 wt. % EVA, 43.4 wt. % styrenic block copolymer, 30 wt. % tackifier, and 6.6 wt. % mineral oil. The EVA was ELVAX® ethylene-vinyl acetate copolymer having 9 wt. % vinyl acetate. The styrenic block copolymer, tackifier, and mineral oil were the same as described above for Example 1.

The individual constituents of Comparative Example 6 were compounded using the previously described single stage twin-screw extrusion process. The composition of Comparative Example 6 was tested for density, melt index (I₂) at a temperature of 190° C. and a load of 2.16 kg, and melt flow rate at a temperature of 230° C. and a load of 2.16 kg. The results for the density, melt index (I₂), and melt flow rate for the composition of Comparative Example 6 are provided below in Table 2.

### Example 7: Comparison of Properties of the Compositions of Example 1 and Comparative Examples 2-6

Table 2, which is provided below, includes the density, melt index (I₂), and melt flow rate for the composition of Example 1 and the adhesive compositions of Comparative Examples 2-6.

TABLE 2
Properties of the composition of Example 1 compared to the properties
of the adhesive compositions of Comparative Examples 2-4

| | Density | Melt Index (I2) | MFR |
|---|---|---|---|
| Example | (g/cm³) | (g/10 min) | (230° C./2.16 kg) |
| Ex. 1 | 0.904 | 10.0 | 32.5 |
| Comp. Ex. 2 | 0.907 | 8.6 | 26.3 |
| Comp. Ex. 3 | 0.913 | 13.8 | 53.7 |
| Comp. Ex. 4 | >0.920 | 56.5 | N/A |
| Comp. Ex. 5 | 0.942 | 20.4 | 127.6 |
| Comp. Ex. 6 | 0.933 | 44.1 | 151.1 |

The composition of Example 1 and the adhesive compositions of Comparative Examples 2, 3, 5, and 6 were additionally tested using DSC to determine the melting curves of the compositions, from which the crystallization temperatures (Tc ° C.), melt temperature (Tm ° C.), glass transition temperature (Tg ° C.), heat of crystallization (ΔHc joules/gram (J/g)), and heat of melting (ΔHm J/g) for each composition, in accordance with the testing procedure previously described herein. These properties are provided below in Table 3. The composition of Example 1 and the adhesive compositions of Comparative Examples 2, 3, 5, and 6 were additionally testing using DMS to determine the dynamic melt viscosity (η*millipascal seconds (mPa-s)) at 150° C., the ratio of the dynamic melt viscosity at 0.1 radians per second to the dynamic melt viscosity at 100 radians per second at a temperature of 150° C. (η*ratio at 150° C.), and the storage modulus (G′ @ 25° C. dyne/cm²) for each composition, according to the DMS testing procedure previously described herein. The results of the DMS testing are provided below in Table 3. The composition of Example 1 was tested two times, and the results reported in Table 3 below as Ex. 1-A and 1-B.

TABLE 3
Melt temperature, crystallization temperature, dynamic melt viscosity, and storage
modulus data for the compositions of Example 1 and Comparative Examples 2-6

| | Ex. 1-A | Ex. 1-B | Comp. 2 | Comp. 3 | Comp. 5 | Comp. 6 |
|---|---|---|---|---|---|---|
| T_{c1} (° C.) | 16.5 | 17.2 | 101.6 | 101.5 | — | 78.8 |
| T_{c2} (° C.) | — | — | — | — | — | 52.1 |
| ΔH_{c} (J/g) | 16.3 | 14.9 | 22.0 | 19.5 | — | 17.0 |
| T_{g} (° C.) | −54.55 | −53.7 | −52.2 | −53.1 | −54.7 | −52.0 |
| Tₘ₁ (° C.) | 42.2 | 43.2 | 119.3 | 119.0 | — | 93.0 |
| ΔHₘ (J/g) | 16.9 | 18.1 | 18.6 | 16.4 | — | — |
| η* (mPa-s) | 4.0 × 10⁶ | 3.3 × 10⁶ | 3.3 × 10⁶ | 3.1 × 10⁶ | 7.9 × 10⁶ | 2.0 × 10⁶ |
| 150° C. | | | | | | |
| η* ratio at | 8.9 | 7.7 | 17.5 | 17.0 | 64.9 | 11.8 |
| 150° C. | | | | | | |

As shown in Table 3 above, the composition of Examples 1-A and 1-B exhibited a lower crystallization temperature and melt temperature profile compared to the adhesive compositions of Comparative Examples 2, 3, 5, and 6. Without being bound by theory, it is believed that lower crystallization and melting temperatures may reduce or prevent secondary crystallization of the constituents of the composition, which increases the cohesive strength of the composition. Increased cohesive strength may provide lower opening force for the composition and more tackiness, which increases the reclose force. Thus, the lower crystallization and melting temperatures of the composition of Example 1 (Ex. 1-A, 1-B) may reduce or prevent secondary crystallization of the composition, thereby increasing the cohesive strength of the composition compared to the compositions of Comparative Examples 2, 3, 5, and 6. The lower crystallization and melting temperatures of the composition of Example 1 enables the composition of Example 1 to exhibit a greater reclose force compared to the compositions of Comparative Examples 2, 3, 5, and 6.

Additionally, the dynamic melt viscosity ratio (η*ratio) at 150° C. for the composition of Examples 1-A and 1-B were less than the dynamic melt viscosity ratios of Comparative Examples 2, 3, 5, and 6. Without being bound by theory, it is believed that a lower dynamic melt viscosity ratio translates to more consistent behavior in response to different shear rates, such as the different shear rates experienced by the film layer during film fabrication (e.g., blown film extrusion) or sealing conditions. The compositions of Comparative Examples 2, 3, 5, and 6 have greater dynamic melt viscosity ratios, and therefore it is expected to be harder to maintain a stable bubble during blown film extrusion if shear rate changes. Additionally, the adhesive layer made from the compositions of Comparative Examples 2, 3, 5, and 6 could thin out to a greater extent with increases in sealing pressure, which would reduce the thickness of the adhesive layer and reduce the amount of adhesive composition to enable cohesive peeling through the adhesive and packaging resealing. The composition of Examples 1-A and 1-B, which exhibited a reduced dynamic melt viscosity ratio of the compared to the compositions of Comparative Examples 2, 3, 5, and 6, is less sensitive to changes in shear rates, and therefore, the compositions of Examples 1-A and 1-B may be easier to process into the multilayer film and provide more consistent performance over a range of sealing temperatures and pressures compared to the compositions of Comparative Examples 2, 3, 5, and 6.

### Example 8: Multilayer Films with the Compositions of Example 1 and Comparative Examples 2-4

In Example 8, each of the composition of Example 1 and adhesive compositions of Comparative Examples 2 and 3 were used to make a multilayer film to evaluate the reclose properties of the compositions. The multilayer films were five-layer films made using blown film extrusion and included Layer A, Layer B, Layer C, Layer D, and Layer E. Layer A was a seal layer comprising 98.4 wt. % DOW LDPE 5004i, 1.0 wt. % AMPACET 10063 antiblock masterbatch available from Ampacet Corporation, and 0.6 wt. % AMPACET 10090 slip masterbatch available from Ampacet Corporation. Layer B included the composition of Example 1 or one of the adhesive compositions of Comparative Examples 2-4. Layers C, D, and E all included identical layers of 100 wt. % DOWLEX 2038.68G LLDPE. The formulations for each multilayer film of Example 8 are provided below in Table 4.

TABLE 4
Multilayer film formulations for Example 8

| Ex. | Ex. 8A | Comp. 8B | Comp. 8C |
|---|---|---|---|
| Thickness (mil) | 3 | 3 | 3 |
| Layer A | LDPE 5004i | LDPE 5004i | LDPE 5004i |
| Layer B | Ex. 1 | Comp. 2 | Comp. 3 |
| Layer C | DOWLEX | DOWLEX | DOWLEX |
| | 2038.68G | 2038.68G | 2038.68G |
| Layer D | DOWLEX | DOWLEX | DOWLEX |
| | 2038.68G | 2038.68G | 2038.68G |
| Layer E | DOWLEX | DOWLEX | DOWLEX |
| | 2038.68G | 2038.68G | 2038.68G |
| Layer ratio (%) | 10/20/20/20/30 | 10/20/20/20/30 | 10/20/20/20/30 |

The blown film extrusion samples were fabricated using a LABTECH 5-layer blown film line, and each layer was formed at the same temperature of 190° C. The heat seal layer was positioned on the outside of the bubble, and the material was self-wound on uptake rollers. Film fabrication conditions for films 6A-6C are shown in Table 5.

TABLE 5
Blown film fabrication conditions for making
the multilayer films of Example 8

| Film ID | 6A | 6B | 6C |
|---|---|---|---|
| Output (kg/hr) | 30-35 | 17.3 | 17.3 |
| Gauge (micron) | 70 | 76.2 | 76.2 |
| Layflat (cm) | 31.75 | 33.0 | 33.0 |
| Line speed (m/min) | <1.5 | 5.0 | 5.0 |

Melt temperature (° C.)

| | | | |
|---|---|---|---|
| Extruder 1 | 215° C. | 207 | 207 |
| Extruder 2 | 190° C. | 152 | 152 |
| Extruder 3 | 220° C. | 218 | 218 |
| Extruder 4 | 220° C. | 214 | 214 |
| Extruder 5 | 220° C. | 211 | 211 |

Melt pressure (megapascals)

| | | | |
|---|---|---|---|
| Extruder 1 | <5500 | 6 | 6 |
| Extruder 2 | <5500 | 7 | 7 |
| Extruder 3 | <5500 | 23 | 23 |
| Extruder 4 | <5500 | 31 | 31 |
| Extruder 5 | <5500 | 21 | 21 |

The multilayer films of Example 8 and shown in Tables 4 and 5 are of good integrity. These multilayer films of Example 8 are flexible films, formed from only coextrudable polymer formulations. These multilayer films can be used for packaging products, and can be processed on conventional film converting equipment.

A fourth film, comparative film 8D, was obtained and evaluated. Comparative film 8D was a commercially-available multilayer film believed to have been made by a blown film process at conditions typical in the blown film industry. The film 8D included a pressure sensitive adhesive layer that was found to include primarily an SIS block copolymer. The film 8D was found to not include a polyethylene copolymer of any kind.

Each of the multilayer film 8A, and comparative films 8B, 8C, and 8D of Example 8 were adhesively laminated to a 48 gauge biaxially oriented polyethylene terephthalate (PET) (available from DuPont Teijin) using MORFREE 403A (solventless adhesive) and co-reactant C411 (solvent-less adhesive) both of which are available from the Dow Chemical Company, Midland Mich., to form a final laminate film structure (sealant/PSA/core (3 layers)/solventless adhesive/PET). The multilayer films of Example 8 were tested for initial peel strength and reclose peel strength according to the peel adhesion test previously described herein. The reclose peel strength for each film was measured at time intervals after the initial opening peel strength. The result for the initial peel strength and subsequent reclose peel strengths for each of film 8A, and comparative films 8B, 8C, and 8D are provided below in table 6. The peel strength measurements are in units of newtons per inch (N/in) in Table 6 below.

TABLE 6
Initial peel adhesion and reclose peel adhesion for the multilayer films of Example 8

| | | Initial | | | | | | | | |
|---|---|---|---|---|---|---|---|---|---|---|
| Film | | Peel | | | | | | | | |
| ID/Seal Temp | | Strength | | | | | | | | |
| (° C.) | Layer B | (N/in) | Reopen Peel Strength (N/in) | | | | | | | |
| | | | 20 | 20 | 20 | 20 | 30 | 20 | 60 | 20 |
| Film 6A | Ex. 1 | Time = 0 | min | min | min | min | min | min | min | min |
| 130 | Ex. 1 | 34.7 | 5.7 | 3.7 | 2.9 | 2.8 | 2.5 | NA | 2.3 | 2.2 |
| 150 | Ex. 1 | 40.5 | 7.7 | 4.7 | 3.9 | 3.1 | 3.1 | NA | 2.7 | 2.4 |
| | | | 20 | 20 | 20 | 20 | 30 | 20 | 60 | 20 |
| Comp. 6B | Comp. 2 | Time = 0 | min | min | min | min | min | min | min | min |
| 130 | Comp. 2 | 43.8 | 6.6 | 4.4 | 3.7 | 3.2 | 2.9 | NA | 2.5 | 2.1 |
| 150 | Comp. 2 | 44.5 | 6.9 | 5.5 | 4.6 | 4.0 | 3.3 | NA | 2.6 | 2.4 |
| | | | 20 | 20 | 20 | 20 | 20 | 50 | 20 | 20 |
| Comp. 6C | Comp. 3 | Time = 0 | min | min | min | min | min | min | min | min |
| 130 | Comp. 3 | 27.7 | 4.6 | 3.8 | 3.3 | 2.5 | 2.2 | 2.4 | 2.1 | 1.9 |
| 140 | Comp. 3 | 29.0 | 3.9 | 2.9 | 2.0 | 1.8 | 1.8 | 1.4 | 1.4 | 1.3 |
| 150 | Comp. 3 | 30.6 | 3.2 | 2.0 | 1.5 | 1.1 | 1.0 | 1.0 | 0.9 | 0.8 |
| | | | 20 | 20 | 20 | 20 | 20 | 50 | 20 | 20 |
| Comp. 6D | Comp. 4 | Time = 0 | min | min | min | min | min | min | min | min |
| 140 | Comp. 4 | 22.6 | 0.3 | 0.2 | 0.1 | 0.1 | 0.1 | 0.1 | 0.1 | 0.1 |
| 150 | Comp. 4 | 18.7 | 1.2 | 0.6 | 0.4 | 0.1 | 0.1 | 0.3 | 0.1 | 0.0 |

As shown in Table 6 above, film 8A, which included the composition of Example 1, exhibited an initial peel strength 34.7 N/in at a heat seal temperature of 130° C. After being heat sealed at a temperature of 130° C. and initially opened, film 8A exhibited a reclose peel adhesion of at least 2.5 N/in through four reclose cycles and a reclose peel adhesion of greater than 2.0 N/in after at least 7 reclose cycles. At a sealing temperature of 150° C., the initial peel adhesion strength of film 8A was 40.5 N/in and the reclose peel adhesion strength was greater than 3 N/in after four reclose cycles and greater than 2.0 after at least 7 reclose cycles.

Comparative film 8D, which was made with the adhesive composition of Comparative Example 4 that included mostly a styrene block copolymer, exhibited an initial peel strength 18.7 N/in at a heat seal temperature of 150° C. After being heat sealed at a temperature of 150° C. and initially opened, comparative film 8D exhibited a reclose peel adhesion of less than 1.0 N/in through four reclose cycles and negligible reclose peel adhesion of less than 0.1 N/in after at least 7 reclose cycles. Thus, at an initial sealing temperature of 150° C., initial peel strength of 40.5 N/in of the film 8A made with the composition of Example 1 was substantially higher than the initial peel strength of the comparative film 8D that included the styrene block copolymer pressure sensitive adhesive (PSA) of Comparative Example 4. Film 8A also exhibited a substantially greater reclose peel strength after 4 cycles and 7 cycles compared to the comparative film 8D that included the styrene block copolymer PSA of Comparative Example 4.

Comparative film 8B included the adhesive composition of Comparative Example 2 for Layer B. The adhesive composition of Comparative Example 2 included 43.4 wt. % of an ethylene/α-olefin block copolymer and 20 wt. % styrenic block copolymer. The film 8A included the composition of Example 1, which comprised 43.4 wt. % of the ethylene/α-olefin random copolymer. Thus, the difference in composition between the composition of Example 1 and the adhesive composition of Comparative Example 2 is the substitution of the ethylene/α-olefin random copolymer in Example 1 for the ethylene/α-olefin block copolymer used in Comparative Example 2. At a sealing temperature of 130° C., film 8A, which included the composition of Example 1, exhibited an initial peel strength of 34.7 N/inch. Comparative film 8B, which included the adhesive composition of Comparative Example 2, exhibited an initial peel strength of 43.8 N/inch. Thus, film 8A resulted in a lower initial peel strength compared to the initial peel strength of comparative film 8B. The reclose peel strength of film 8A after 4 cycles and after 7 cycles was comparable to the reclose peel strength of comparative film 8B that included the adhesive composition of Comparative Example 2. The results measured after heat sealing at 150° C. exhibited a similar comparative relationship to the films prepared at a heat sealing temperature of 130° C. These results for film 8A and comparative film 8B indicate that the film 8A requires a lesser initial opening force compared to comparative film 8B, but would provide equivalent reclose performance. Therefore, film 8A would be easier to initially open compared to comparative film 8B, but would provide equivalent reclose strength to comparative film 8B.

Comparative film 8C included the adhesive composition of Comparative Example 3, which included only 33.4 wt. % of the ethylene/α-olefin block copolymer and 30 wt. % styrenic block copolymer. Thus, Layer B of comparative film 8C had an increased proportion of styrenic block copolymer and decreased amount of ethylene/α-olefin block copolymer compared to Layer B of comparative film 8B and film 8A. As shown by the results in Table 6, increasing the amount of the styrenic block copolymer in Layer B reduces the initial peel strength of the comparative film 8C compared to the initial peel strength of film 8A. However, the increased amount of styrenic block copolymer in Layer B of comparative film 8C was observed to degrade the reclose peel strength performance of comparative film 8C compared to the reclose peel strength of film 8A. The degradation in the reclose peel strength performance of comparative film 8C is more pronounced after sealing comparative example 8C at the seal temperature of 150° C. Although increasing the amount of styrenic block copolymer in Layer B, such as with comparative film 8C, may decrease the initial peel strength and make the film easier to open, increasing the amount of the styrenic block copolymer in Layer B may adversely affect the reclose peel strength, resulting in weaker reclose seal strength and a reduction in the number of reclose cycles possible for the film. Thus, film 8A that included the composition of Example 1 in Layer B may provide better reclose performance compared to the comparative film 8C, which included an increased amount of styrenic block copolymer in Layer B.

Film 8A has a lesser amount of styrenic block copolymer in Layer B compared with comparative films 8C and 8D. Therefore, film 8A may provide reclose functionality to food packaging without impacting the odor and/or taste of the food products packaged therein.

Throughout this disclosure ranges are provided for various properties of the adhesive composition, reclosable film, and reclosable packaging made therewith, including the adhesive composition and multilayer film disclosed herein. It will be appreciated that when one or more explicit ranges are provided the individual values and the ranges formed therebetween are also intended to be provided, as providing an explicit listing of all possible combinations is prohibitive. For example, a provided range of 1-10 also includes the individual values, such as 1, 2, 3, 4.2, and 6.8, as well as all the ranges which may be formed within the provided bounds, such as 1-8, 2-4, 6-9, and 1.3-5.6.

It should now be understood that various aspects of the adhesive composition, reclosable films, and reclosable packaging that include the reclosable films are described and such aspects may be utilized in conjunction with various other aspects. It should also be understood to those skilled in the art that various modifications and variations can be made to the described embodiments without departing from the spirit and scope of the claimed subject matter. Thus, it is intended that the specification cover the modifications and variations of the various described embodiments provided such modification and variations come within the scope of the appended claims and their equivalents.

1. A package comprising a container including an elongate closure region proximate to at least one edge of the container and bounded on both ends by edge seal regions, the closure region comprising a reclosable film that seals the container proximate to at least one edge of the container and has an initial opening strength less than a seal strength of the edge seal regions, wherein:
the application of an opening force to the reclosable film that is greater than the initial opening strength of the reclosable film is operable to separate the reclosable film to expose a first reclose surface and a second reclose surface; and
contact of the first reclose surface with the second reclose surface and the application of a pressure to the reclosable film is operable to re-adhere the first reclose surface to the second reclose surface at a reclose strength.

2. The package of claim 1, wherein the container is a flexible container.

3. The package of claim 1, wherein the container comprises a first flexible wall and a second flexible wall and the closure region seals the first flexible wall to the second flexible wall.

4. The package of claim 3, wherein the first flexible wall, the second flexible wall, or both includes the reclosable film.

5. The package of claim 1, wherein the reclosable film is disposed between a first flexible wall and a second flexible wall of the container in the closure region.

6. The package of claim 1, wherein the closure region and the edge seal regions cooperate to seal the container.

7. The package of claim 1, wherein the closure region is non-linear.

8. The package of claim 7, wherein the at least one outer edge of the container is non-linear and the closure region conforms to a non-linear contour of the at least one outer edge of the container.

9. The package of claim 1, wherein the reclosable film comprises a multilayer film.

10. The package of claim 9, wherein the multilayer film comprises at least 3 layers, wherein:
a Layer A comprises a sealant and is sealed to the first flexible film or the second flexible film in the closure region;
a Layer B comprises an adhesive composition having an internal cohesion strength less than the seal strength of Layer A;
a Layer C comprises a structural material or a sealant; and
Layer B includes a top facial surface in adhering contact with a bottom facial surface of Layer A and a bottom facial surface in adhering contact with a top facial surface of Layer C.

11. The package of claim 1, further comprising an unsealed region disposed between the closure region and the at least one edge of the container.

12. The package of claim 11, wherein the unsealed region is elongate and parallel to the closure region and extends an entire length of the closure region.

13. A method of making a reclosable package, the method comprising:
sealing a first flexible wall of a container to a second flexible wall of the container in an elongate closure region at a first temperature and a first pressure, wherein the closure region is proximate to at least one edge of the container and is bounded on both ends by edge seal regions, the closure region comprising a reclosable film that seals the container proximate to at least one edge of the container and provides reclose functionality to the reclosable package after initial opening of the reclosable package;
sealing the first flexible wall to the second flexible wall in the edge seal regions at a second temperature and a second pressure, wherein the second temperature is different than the first temperature or the second pressure is different than the first pressure;
wherein an initial opening strength of the closure region is less than an initial opening strength of the edge seal regions.

14. The method of claim 13, wherein the first flexible wall, the second flexible wall, or both comprise the reclosable film.

15. The method of claim 13, further comprising positioning a strip of the reclosable film between the first flexible wall and the second flexible wall in the elongate closure region.
